(19) United States
(12) Patent Application Publication
(10) Pub. No.: US 2024/0151356 A1
(43) Pub. Date: May 9, 2024

(54) SYSTEMS AND METHODS FOR MONITORING HYDROGEN FUEL

(71) Applicant: Nikola Corporation, Phoenix, AZ (US)

(72) Inventors: Livio Gambone, Phoenix, AZ (US); Alexander Grab, Phoenix, AZ (US); Renju Zacharia, Phoenix, AZ (US)

(21) Appl. No.: 18/502,833

(22) Filed: Nov. 6, 2023

Related U.S. Application Data
(60) Provisional application No. 63/423,721, filed on Nov. 8, 2022.

(51) Int. Cl. F17C 5/00; B60K 15/07; B60L 50/70; F17C 5/02; H01M 8/04082; H01M 8/04089; H01M 8/0432; H01M 8/04746

(52) U.S. Cl. CPC F17C 5/007; B60K 15/07; B60L 50/70; F17C 5/02; H01M 8/04089; H01M 8/04201; H01M 8/0432; H01M 8/04753; B60K 2015/03315; F17C 2205/013; F17C 2205/0326; F17C 2221/012; F17C 2223/033; F17C 2223/036; F17C 2250/03; F17C 2250/043; F17C 2250/0439; F17C 2250/0636; F17C 2265/065; F17C 2270/0171; F17C 2270/0184; H01M 2250/20

(57) ABSTRACT

The present disclosure provides systems and methods for monitoring temperature and pressure of a hydrogen storage system. Various temperature and pressure sensors are used to monitor temperature and pressure in one or more tanks of hydrogen gas.

### CROSS REFERENCE TO RELATED APPLICATIONS

This application is nonprovisional of, claims priority to and the benefit of, U.S. Provisional Patent Application No. 63/423,721, filed Nov. 8, 2022 and titled “SYSTEMS AND METHODS FOR MONITORING HYDROGEN FUEL,” which is incorporated by reference herein in its entirety for all purposes.

### TECHNICAL FIELD

The present disclosure relates to systems for monitoring hydrogen gas, and more particularly, to monitoring hydrogen gas used as fuel in, for example, fuel cell vehicles.

### BACKGROUND

Fuel cell electric vehicles (FCEVs) facilitate oxidation-reduction (redox) reactions between oxygen and hydrogen in a fuel cell system to generate electrical energy. More specifically, as hydrogen enters the fuel cell system, electrons are disassociated from hydrogen molecules and passed through an external circuit in order to perform work, while protons are passed through an internal membrane. At the cathode, the protons recombine with the electrons and oxygen in an exotherm is reaction to form water and heat, which are exhausted to the external environment along with some amount of unreacted hydrogen and air. Given the care with which hydrogen gas should be handled, monitoring fuel storage systems that house hydrogen gas is important for safety, among other things.

### SUMMARY

The contents of this section are intended as a simplified introduction to the disclosure and are not intended to limit the scope of any claim. The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

A hydrogen storage system for a fuel cell electric vehicle (FCEV) is provided, comprising, a controller in electronic communication with a first tank and a second tank, the first tank having a first tank on tank valve (OTV) temperature sensor and the second tank having a second tank OTV temperature sensor; and a non-transitory computer-readable storage medium in electronic communication with the controller, having instructions stored thereon that, in response to execution by the controller, cause the controller to perform operations comprising: receiving, by the controller, a first temperature from the first tank OTV temperature sensor, receiving, by the controller, a second temperature from the second tank OTV temperature sensor, determining, by the controller, whether the first temperature is at least one of greater than or equal to a predetermined temperature, determining, by the controller, whether the second temperature is at least one of greater than or equal to the predetermined temperature, in response to finding that at least one of the first temperature or the second temperature at least one of is greater than or equal to the predetermined temperature, transmitting, by the controller, a stop fuel command.

### BRIEF DESCRIPTION OF THE DRAWINGS

The accompanying drawings are included to provide a further understanding of the present disclosure and are incorporated in, and constitute a part of, this specification, illustrate various embodiments, and together with the description, serve to explain exemplary principles of the disclosure.

FIG. 1 illustrates a perspective view of an FCEV incorporating a fuel cell exhaust system, in accordance with various embodiments;

FIG. 2 illustrates a bottom view of an FCEV incorporating a fuel cell exhaust system, in accordance with various embodiments;

FIGS. 3A and 3B illustrate an arrangement of tanks, in accordance with various embodiments;

FIG. 4 illustrates a gas monitoring system, in accordance with various embodiments;

FIG. 5 illustrates a gas monitoring process that monitors temperature during fueling, in accordance with various embodiments;

FIG. 6 illustrates a gas monitoring system that monitors pressure during fueling, in accordance with various embodiments;

FIG. 7 illustrates a gas monitoring system that monitors temperature across various tanks, in accordance with various embodiments;

FIG. 8 illustrates a gas monitoring system that monitors temperature across various tanks prior to or during a drive state, in accordance with various embodiments;

FIG. 8 illustrates a gas monitoring system that monitors temperature across various tanks prior to or during a drive state, in accordance with various embodiments;

FIG. 9 illustrates a gas monitoring process that monitors temperature during fueling to detect safety issues, in accordance with various embodiments;

FIG. 10 illustrates a gas monitoring process that monitors pressure during fueling to detect safety issues, in accordance with various embodiments;

FIG. 11 illustrates a gas monitoring process that monitors temperature during defueling to detect safety issues, in accordance with various embodiments;

FIG. 12 illustrates a gas monitoring process that determines gas density during fueling to assess fuel capacity, in accordance with various embodiments;

FIG. 13 illustrates a gas monitoring process that determines gas density prior to or during a drive state to assess fuel capacity, in accordance with various embodiments;

FIG. 14 illustrates a gas monitoring process that responds to a finding of a faulty sensor, in accordance with various embodiments;

FIG. 15 illustrates a sensor monitoring process that identifies a faulty sensor, in accordance with various embodiments;

FIG. 16 illustrates a table of potential actions, in accordance with various embodiments;

FIG. 17 illustrates a gas monitoring process that identifies issues with sensors in a plurality of tanks, in accordance with various embodiments;

FIG. 18 illustrates a gas monitoring process that identifies mean temperatures by tank, in accordance with various embodiments;

FIG. 19 illustrates a gas monitoring process that monitors pressures in various aspects, in accordance with various embodiments;

FIG. 20 illustrates a gas monitoring process that monitors average temperatures in various aspects, in accordance with various embodiments;

FIG. 21 illustrates a gas monitoring process that monitors pressures in various aspects, in accordance with various embodiments; and

FIG. 22 illustrates a gas monitoring process that monitors average temperatures in various aspects, in accordance with various embodiments.

### DETAILED DESCRIPTION

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that logical chemical, electrical, and mechanical changes may be made without departing from the spirit and scope of the disclosure. Thus, the detailed description herein is presented for purposes of illustration only and not of limitation.

For example, the steps recited in any of the method or process descriptions may be executed in any suitable order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full, and/or any other possible attachment option. Additionally, any reference to without contact (or similar phrases) may also include reduced contact or minimal contact.

As used herein, “electronic communication” means communication of electronic signals with physical coupling (e.g., “electrical communication” or “electrically coupled”) or without physical coupling and via an electromagnetic field (e.g., “inductive communication” or “inductively coupled” or “inductive coupling”) and/or a radio frequency (RF) communications protocol. In this regard, “electronic communication,” as used herein, includes wired and wireless communications (e.g., Bluetooth, Bluetooth LE, NFC, TCP/IP, Wi-Fi, etc.).

In the context of the present disclosure, methods, systems, and articles may find particular use in connection with medium- and heavy-duty FCEVs. However, various aspects of the disclosed embodiments may be adapted for performance in a variety of other systems, including gasoline/electric hybrid vehicles, compressed natural gas (CNG) vehicles, hythane (mix of hydrogen and natural gas) vehicles, and/or the like. Accordingly, numerous applications of the present disclosure may be realized.

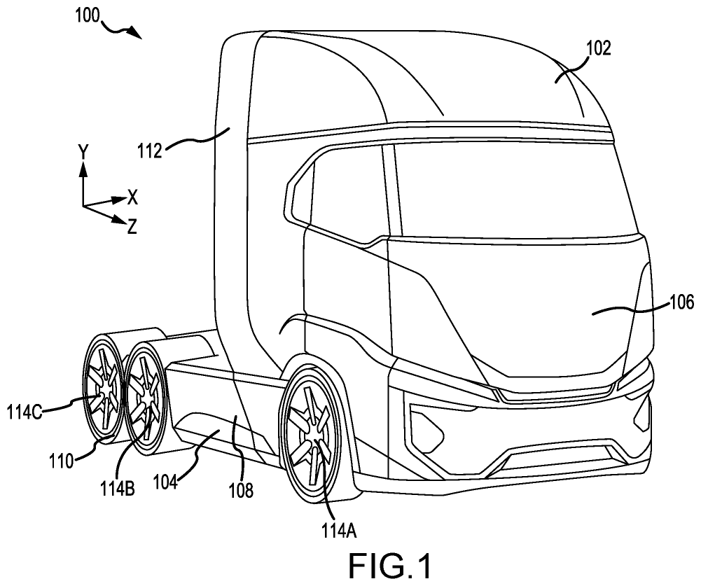

Accordingly, with reference to FIG. 1, an FCEV 100 is illustrated from a top perspective view, in accordance with various embodiments. As illustrated in FIG. 1, FCEV 100 is a heavy-duty FCEV. FCEV 100 is a tractor unit which may tow a trailer unit configured to hold and transport cargo. FCEV 100 may comprise a class 8, class 7, class 6, or any other weight classification of tractor-trailer combination. As described herein, FCEV 100 extends in a longitudinal direction along the Z-axis from a rear of FCEV 100 to a front of FCEV 100. FCEV 100 extends in a transverse direction along the X-axis from a passenger side of FCEV 100 to a driver side of FCEV 100. Finally, FCEV 100 extends in a vertical direction along the Y-axis from a ground surface on which FCEV 100 drives to a top of FCEV 100.

FCEV 100 comprises a cab 102 supported by a chassis 104. Cab 102 may be configured to shelter one or more vehicle operators or passengers from the external environment. In various embodiments, cab 102 comprises a door configured to allow ingress and egress into and from cab 102, one or more seats, a windshield, and numerous accessories configured to improve comfort for the operator and/or passenger(s). As illustrated in FIG. 1, FCEV 100 comprises a cab-over or cab-forward style tractor unit, but is not limited in this regard and may comprise any style of tractor unit including a conventional or American cab style tractor unit.

Chassis 104, otherwise known as the vehicle frame, is configured to support various components and systems of FCEV 100 including cab 102. Chassis 104 may comprise a ladder-like structure with various mounting points for FCEV 100's suspension, powertrain, energy storage systems (ESS) (for example, fuel cell system(s) and/or battery system(s)), and other systems. Chassis 104 supports and is coupled to a fuel cell system 106 which may be configured to facilitate an electrochemical reaction in order to generate electrical energy that can be used to drive FCEV 100 and operate electric components and systems of FCEV 100. Chassis 104 may be covered by one or more side covers 108 configured to provide corrosion-resistance and improved aerodynamics along the sides of FCEV 100. FCEV 100 further comprises wheels 110 comprising one or more tires coupled to one or more axles 114 and configured to roll along a driving surface. In various embodiments, FCEV 100 comprises a pair of single wheels coupled to a front axle 114A and a pair of dual wheels coupled to two rear axles (first rear axle 114B and second rear axle 114C). One or more of the axles may be driven. For example, in various embodiments, FCEV 100 may comprise a 6×2 configuration with a single driven axle; however, FCEV 100 is not limited in this regard and may comprise a 4×2, 6×4, 6×6, or other suitable configuration. In various embodiments, FCEV 100 may further comprise a hydrogen storage system 112 configured to contain and deliver hydrogen fuel to fuel cell system 106.

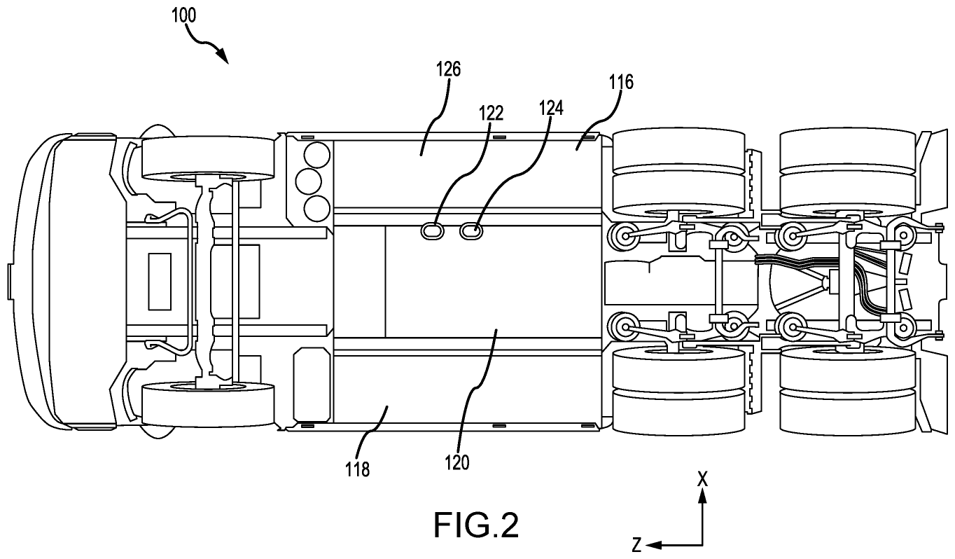

With reference to FIG. 2, FCEV 100 is illustrated from a bottom view, in accordance with various embodiments. In various embodiments, FCEV 100 comprises an undercarriage 116 that comprises a first outboard skid plate 118, an inboard skid plate 120, and a second outboard skid plate 126. First outboard skid plate 118 is positioned adjacent to the passenger side of FCEV 100 and is coupled to a first frame rail of chassis 104 on a first side and coupled to a first side cover 108 on a second side. Similarly, second outboard skid plate 126 is positioned adjacent to the driver side of FCEV 100 and is coupled to a second frame rail of chassis 104 on a first side and coupled to a second side cover 108 on a second side. Inboard skid plate 120 is positioned between the first outboard skid plate 118 and the second outboard skid plate 126 and is coupled to the first frame rail of chassis 104 on a first side and coupled to the second frame rail of chassis 104 on a second side.

Inboard skid plate 120 comprises a first exhaust aperture 122 and a second exhaust aperture 124 adjacent to and rearward of first exhaust aperture 122. As illustrated, first exhaust aperture 122 and second exhaust aperture 124 extend through inboard skid plate 120 adjacent to second outboard skid plate 126. More specifically, first exhaust aperture 122 and second exhaust aperture 124 are located adjacent to and inboard of the second frame rail of chassis 104; however, the positioning of first exhaust aperture 122 and second exhaust aperture 124 is not limited in this regard and the apertures may be positioned adjacent to and inboard of the first frame rail of chassis 104, centered in the transverse direction on inboard skid plate 120, or positioned at any suitable location in the transverse location on first outboard skid plate 118 or second outboard skid plate 126. Moreover, while illustrated as comprising two separate exhaust apertures, FCEV 100 is not limited in this regard and may comprise a single exhaust aperture in various embodiments.

In various embodiments, first exhaust aperture 122 and second exhaust aperture 124 are configured to permit exhaust gases and water to exit fuel cell system 106 (and FCEV 100) and be delivered to the external environment (for example, to the ground). More specifically, as fuel cell system 106 operates, fuel cell system 106 generates water and/or water vapor and heat to be exhausted to the external environment along with some amount of unreacted hydrogen and air. In various embodiments, first exhaust aperture 122 and second exhaust aperture 124 overlap with fuel cell system 106 in the transverse direction and are positioned rearward of fuel cell system 106. First exhaust aperture 122 and second exhaust aperture 124 may be located such that one or more exhaust ducts extending between fuel cell system 106 and the exhaust apertures occupy reduced and/or minimized volume on FCEV 100.

The storage, fueling, defueling, and use of compressed gases such as hydrogen gas (H₂) in a vehicle may be associated with enhanced energy efficiency, improved environmental impact profile, and decreased reliance on fossil fuels. As discussed above, hydrogen gas may be combined with oxygen in a fuel cell to yield electrical energy and water. This reduces or eliminates the need for a vehicle to consume fossil fuels directly and/or emit pollutants such as NOₓ, SOₓ, CO₂, and various hydrocarbons into the atmosphere, such as would occur in a fossil fuel burning engine, such as a compression ignition engine (e.g., Diesel engine) or internal combustion engine (“ICE” e.g., gasoline powered engine such as an Otto cycle ICE and/or Atkinson cycle ICE).

FCEV 100 may be operated in various modes. Fueling mode comprises a mode whereby hydrogen gas is conducted into hydrogen storage system 112. A fueling station may connect to hydrogen storage system 112 via one or more fluid connections. Further, a fueling station may comprise one or more wired or wireless interfaces that communicate data to and from FCEV 100 and the fueling station. Other fueling stations, however, do not have such data communication links. Defueling mode may comprise a mode whereby hydrogen gas is released from hydrogen storage system 112 and either fed to a fuel cell or vented to the ambient environment. Drive-ready mode or status comprises a mode wherein FCEV 100 remains stationary, but one or more power systems may be active and the FCEV 100 is ready to be driven. Drive-ready mode or status may be comparable to the “idle” state of a conventional fossil fuel burning vehicle. Drive mode comprises a state whereby FCEV 100 is in motion under its own power. One or more fuel cells may be functioning during drive mode, though drive mode also includes a state where FCEV 100 is traveling under battery stored power. Drive mode is thus characterized by current motion of the FCEV 100. Off mode comprises a mode where the FCEV 100 is stationary and awaiting to be put into another mode. Certain systems of FCEV 100 may be active, but FCEV 100 would typically be considered “off” in off mode. FCEV 100 may be operated during driving by a user onboard FCEV 100. However, in various embodiments, FCEV 100 may be operated remotely by a remote user in electronic communication with FCEV 100 to provide driving commands. In still further embodiments, FCEV 100 is operated autonomously through the use of self-driving logic and onboard sensors, such as cameras, LiDAR arrays, IR sensors, and other optical and audio input devices.

Similar to how a fossil fuel burning engine carries flammable petroleum products, FCEVs typically carry hydrogen gas. Like petroleum products, hydrogen gas is flammable. Thus, movement and storage of hydrogen gas should be carefully controlled and, beneficially, monitored accordingly. Moreover, hydrogen gas has a negative Joule-Thompson coefficient at temperatures typically associated with the Earth's surface (i.e., between −20° F. (−28° C.) and 120° F. (49° C.)). This means that hydrogen gas increases in temperature upon being moved into a tank and upon being expelled from a tank through an orifice. Depending upon ambient temperature and the velocity of the gas flowing through the orifice, this increase in temperature may create a hazardous condition. Thus, fueling and defueling a hydrogen gas tank may become hazardous if not properly controlled. Further, should the integrity of the tank become compromised, such as in the event of a fire or vehicular accident, the hydrogen gas stored therein should be vented to prevent or reduce the severity of a fire. These complexities of moving, storing, and using hydrogen gas on a vehicle have traditionally inhibited the adoption of FCEVs, which thus inhibit the conversion of fossil fuel burning vehicles to cleaner alternatives. In that regard, improved monitoring and management for hydrogen gas tanks on vehicles would be associated with improved environmental impact and safer roadways and fueling stations.

FCEVs may comprise more than one tanks of hydrogen gas arranged in an array. The array may be managed as a system, plumbed together to fuel and defuel as a unit. However, the tanks may experience varying conditions from one another during use, which may benefit from a tank-by-tank approach to management. In that regard, managing an array as a whole eases interactions with other onboard systems, while managing each tank in the array closely improves safety and performance. To facilitate management, temperature and fuel sensors may be employed to sense temperature and pressure. The ideal gas law, PV=nRT, relates P=pressure, V=volume, T=temperature, n=number of moles of a gas, and the R=ideal gas constant. The ideal gas law may be used as an approximation for the behavior of hydrogen gas, though of course real gases behave differently than an ideal gas. Thus, given the known tank volume and sensed pressure and temperatures, density of the gas stored therein may be derived. Density of hydrogen gas may be used to monitor for safety and to determine the mass of hydrogen stored, among other things.

Any physical property sensor, such as a temperature sensor or pressure sensor, may become unreliable over time. Such a sensor may become “noisy” meaning that the sensor displays wide variations in signal despite monitoring a steady state system. For example, given a steady state of pressure, a sensor that displays a 15% variance in pressure measurement in measurements taken 1 second apart may be considered “noisy.” Sensors may also fail over time and benefit from replacement. In that regard, vehicular systems should be robust enough to maintain functionality even with at least one pressure and/or temperature sensor having failed or becoming excessively noisy.

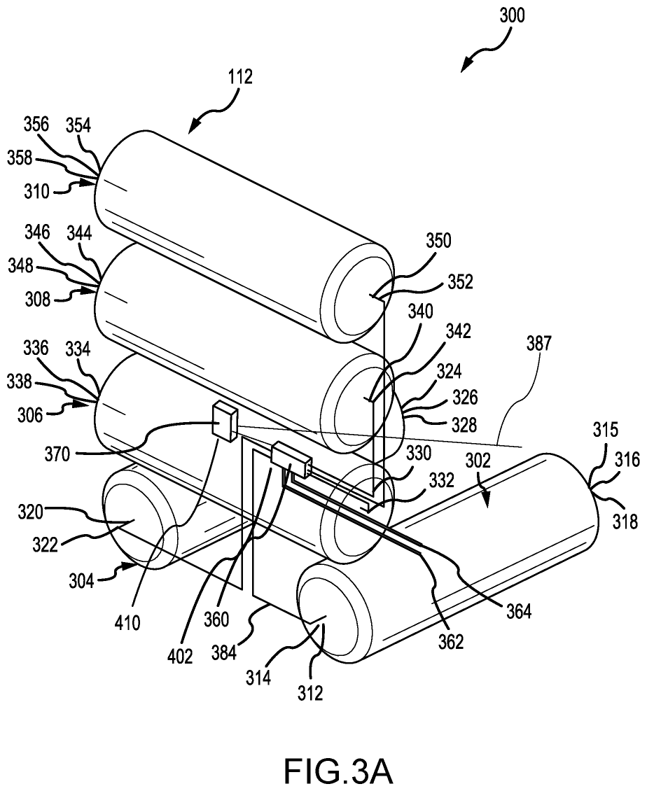

Referring now to FIGS. 3A and 3B, hydrogen storage system 112 is shown including gas monitoring system 300. Gas monitoring system 300 comprises various temperature and pressure sensors in electrical, wireless, and/or logical communication with controller 402 as well as various valves that are also in electrical, wireless, and/or logical communication controller 402.

Hydrogen storage system 112 receives hydrogen gas from input 362 and input 364. Hydrogen gas may be in compressed form. Hydrogen gas is received into manifold 360 and distributed to tanks 302, 304, 306, 308, and 310 via plumbing system 384.

Tanks 302, 304, 306, 308, and 310 comprise a plurality of type III or type IV pressurized vessels. Tanks 302, 304, 306, 308, and 310 may be positioned at the rear of cab 102 and/or on either side of chassis 104 between the frame rails of chassis 104 and side covers 108. In various embodiments, the tanks 302, 304, 306, 308, and 310 may be configured to contain pressurized gaseous or liquid hydrogen at a pressure of between approximately 350 bar (35 MPa) to 875 bar (87.5 MPa), or between approximately 500 (50 MPa) and 750 bar (75 MPa), or approximately 600 bar (60 MPa). In embodiments where liquid hydrogen is employed, the pressure may be between 2 bar (0.2 MPa) and 30 bar (3 MPa). As a result, tanks 302, 304, 306, 308, and 310 may be configured to deliver hydrogen along a downward pressure gradient to a fuel cell system without the need for one or more compressors that may otherwise consume electrical energy and adversely impact vehicle range. In various embodiments where liquid hydrogen is employed, an additional compressor may be employed to pressurize the hydrogen to suit the incoming pressure specifications of the fuel cell.

Manifold 360 may fuel one or more of tanks 302, 304, 306, 308, and 310 in a selectable manner. Regulator 370 receives hydrogen gas from tanks 302, 304, 306, 308, and 310 via plumbing system 384 and conducts hydrogen gas to a fuel cell. A fueling system may be in communication with controller 402 to facilitate hydrogen gas flow, though in various embodiments no such communication may occur. Tanks 302, 304, 306, 308, and 310 are illustrated having tanks 304 and 302 oriented perpendicular to tanks 306, 308, and 310, though other spatial configurations are contemplated herein. Vent system 387 is coupled to regulator 370. In various embodiments, additional lines fluidly coupled to each of tanks 302, 304, 306, 308, and 310 are configured with a mechanical switch to vent in the event of an emergency. Regulator 370, being in fluid communication with manifold 360 and thus each of tanks 302, 304, 306, 308, and 310, experiences pressure from hydrogen gas from all tanks. Regulator 370 may be equipped with a mechanical vent valve (vent valve 410) that is mechanically biased (e.g., biased by a spring) to the closed position. In the event the collective pressure from tanks 302, 304, 306, 308, and 310 overcomes the mechanical bias, regulator 370 may vent hydrogen gas to the ambient environment. Vent valve 410 thus fluidly couples the plumbing of vent system 387 with the ambient environment. In response to the hydrogen gas pressure from tanks 302, 304, 306, 308, and 310 falling below the mechanical bias force, regulator 370 may close the vent valve via the mechanical bias force. Vent system 387 thus fluidly couples hydrogen storage system 112 to the ambient environment. In the event that hydrogen storage system 112 would benefit from emptying hydrogen gas, vent system 387 may be activated in this manner to conduct hydrogen gas away from each of tanks 302, 304, 306, 308, and 310 into the ambient environment where the hydrogen gas may be less of a hazard in the event of overheating.

Hydrogen storage system 112 may comprise valves that are manually, electromechanically, hydraulically, and/or pneumatically actuated. In that regard, a valve assembly may comprise a valve and an electromechanical device that is in electrical, wireless, and/or logical communication with controller 402 such that controller 402 may issue commands to the electrotechnical device to open, close, partially open, or partially close the valve. Various temperature and pressure measurements may be transmitted to controller 402 at various intervals. These intervals are selectable, and may be from 1 ms to 500 ms, from 1 ms to 1 s and from 50 ms to 2 s.

Tank 302 comprises on tank valve (OTV) 312 that comprises OTV temperature sensor 314. OTV 312 receives hydrogen gas from plumbing system 384. End plug (EP) 315 comprises temperature sensor 316 and pressure sensor 318. Tank 304 comprises OTV 320 that further comprises OTV temperature sensor 322. EP 324 comprises temperature sensor 326 and pressure sensor 328. Tank 306 comprises OTV 330 that further comprises OTV temperature sensor 332. EP 334 comprises temperature sensor 336 and pressure sensor 338. Tank 308 comprises OTV 340 that further comprises OTV temperature sensor 342. EP 344 comprises temperature sensor 346 and pressure sensor 348. Tank 310 comprises OTV 350 that further comprises OTV temperature sensor 352. EP 354 comprises temperature sensor 356 and pressure sensor 358. In various embodiments, each OTV may further comprise a pressure sensor. In that regard, each of OTVs 312, 320, 330, 340, and 350 may comprise a pressure sensor.

It should be noted that OTV temperature sensors 314, 322, 332, 342, and 352 may not necessarily observe the same temperature observed by EP temperature sensors 316, 326, 336, 346, and 356 at the same time. As hydrogen gas enters or exits the tank, localized heat transfer, some of which is associated with compressing hydrogen gas or expanding hydrogen gas, may affect the localized temperatures observed at either end of the tank. In that regard, some difference in temperature readings between OTV temperature sensors 314, 322, 332, 342, and 352 and EP temperature sensors 316, 326, 336, 346, and 356 is expected, especially during non-steady state times, such as during fueling and/or defueling/discharge to the fuel cell system.

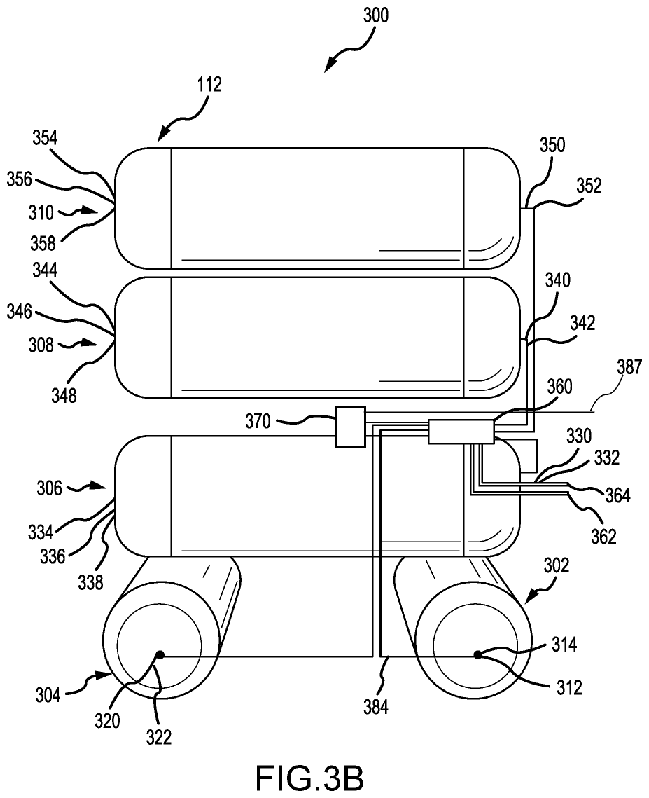

With reference to FIG. 4, gas monitoring system 300 is illustrated schematically. Controller 402 comprises a processor or other hardware that is capable of executing instructions, as further described herein. Controller 402 is in electrical, wireless, and/or logical communication with OTV array 420. OTV array 420 comprises the OTVs of hydrogen storage system 112, namely, OTVs 312, 320, 330, 340, and 350. As described above, OTVs 312, 320, 330, 340, and 350 each comprise an electronically actuated valve in fluid communication with each of tanks 302, 304, 306, 308, and 310 and manifold 360. In that regard, OTVs 312, 320, 330, 340, and 350 may selectively open and close electronically actuated valves and cause each of tanks 302, 304, 306, 308, and 310 to be in fluid communication with manifold 360 (i.e., open electronically actuated valve) or to be fluidly isolated from manifold 360 (i.e., closed electronically actuated valve). Controller 402 is in electrical, wireless, and/or logical communication with fuel station 425 during or nearly before and after, fueling. Fuel station 425 may be a system that is configured to deliver hydrogen gas to FCEV 100. Fuel station 425 may implement various industry standard protocols to control the fueling process. However, in various embodiments, fuel station 425 may not implement such protocols. As discussed here, a shut off valve (SOV) valve may be disposed inline with the hydrogen gas plumbing system that may be electronically actuated. In that regard, in such embodiments, controller 402 and/or fuel station 425 may command such a SOV to actuate.

Controller 402 is in electrical, wireless, and/or logical communication with OTV temperature sensor array 408 (OTV temperature sensors 314, 322, 332, 342, and 352), EP pressure sensor array 406 (EP pressure sensors 318, 328, 338, 348, and 358), and EP temperature sensor array 404 (EP temperature sensors 316, 326, 336, 346, and 356). In various embodiments, controller 402 is in electrical, wireless, and/or logical communication with OTV pressure sensor array 406. OTV pressure sensor array 406 comprises the array of OTV pressure sensors associated with each of OTVs 312, 320, 330, 340, and 350, in various embodiments. Controller 402 is in electronic communication with control systems 440. Control systems 440 may include other controllers, processors, and other electronic devices that control aspects of various systems on FCEV 100. Control systems 440 may exist onboard FCEV 100 or may be remote from FCEV 100. Control systems 440 are in electronic communication and/or mechanical communication with mechanical systems 430. Mechanical systems 430 of FCEV 100 implement various driving functions, such as the braking system, the parking brake, the electric motor(s), onboard lights, onboard displays, and other similar systems.

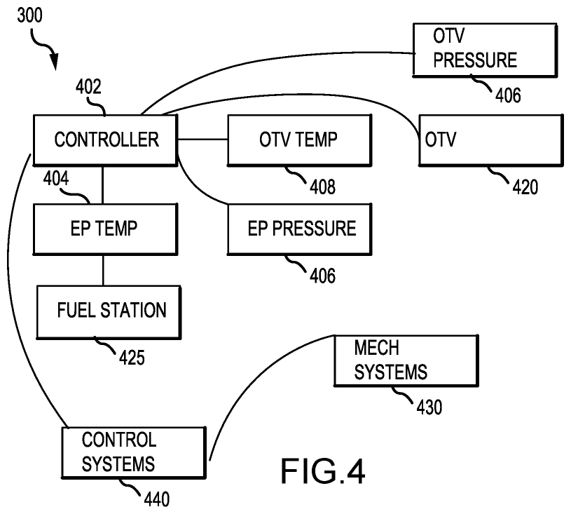

With reference to FIG. 5, fuel monitoring 500 is illustrated. At monitor temperature 502, gas monitoring system 300 monitors temperature in tanks 302, 304, 306, 308, and 310 during fueling. During fueling, hydrogen gas is conducted into tanks 302, 304, 306, 308, and 310 via plumbing system 384. A predetermined temperature, T_{SAFE}, may be selected for hydrogen gas. T_{SAFE} may be considered a temperature that is near a temperature that would create a hazardous situation for the fueling gas, such as hydrogen. T_{SAFE} may alternatively be a temperature that is near a temperature that would result in damage to one or more components of hydrogen storage system 112, for example, tanks 302, 304, 306, 308, and 310. In various embodiments, T_{SAFE} is 82.5° C., though it may range from 80° C.-84° C. An observed temperature, T_{O}, comprises an observed temperature from at least one of OTV temperature sensors 314, 322, 332, 342, and 352 and EP temperature sensors 316, 326, 336, 346, and 356.

At determination 504, a T_{O} is taken from one or more of OTV temperature sensors 314, 322, 332, 342, and 352 and EP temperature sensors 316, 326, 336, 346, and 356. Each T_{O} is individually compared to T_{SAFE}. Provided that each T_{O}<T_{SAFE}, monitor temperature 502 may continue at a desired rate.

If T_{O}>T_{SAFE} or if T_{O}=T_{SAFE}, stop fuel 506 occurs. In that regard, controller 402 may command, via an electronic or wireless communications pathway, a fueling station to cease addition of (i.e., the flow of) hydrogen gas. For example, controller 402 may send a stop fueling signal (e.g., an abort signal) via a wireless communication format such as an infrared data association (IRDA) link employing a SAE J2601 and/or SAE J2799 protocol. In various embodiments, controller 402 may command OTVs 312, 320, 330, 340, and 350 to close, thereby ceasing the fueling of hydrogen storage system 112. In further embodiments, controller 402 may command OTVs 312, 320, 330, 340, and 350 to stop fueling only the tank associated with the sensor that produced the T_{O} that met or exceeded T_{SAFE}. For example, if OTV temperature sensor 314 recorded a T_{O} that met or exceeded T_{SAFE}, controller 402 may command OTV 312 to cease fueling tank 302 yet continue fueling tanks 304, 306, 308, and 310. This may proceed for temperature observations in both OTV temperature sensors 314, 322, 332, 342, and 352 and EP temperature sensors 316, 326, 336, 346, and 356. In other words, controller 402 may command OTVs 312, 320, 330, 340, and 350 to stop fueling a particular tank if that tank has at least one temperature reading of either OTV temperature sensor or EP temperature sensor that meets or exceeds T_{SAFE}. In this regard, only the tank that has met or exceeded T_{SAFE} experiences a stoppage of fueling. Where a fueling line includes an electronically actuated valve, controller 402 may directly, wirelessly, or otherwise communicate with the electronically actuated valve to cease fueling. Such an electronically actuated valve would be part of the fuel station hardware and in fluid communication with input 362 and/or input 364.

After a predetermined amount of time, fuel monitoring 500 may continue, even for tanks that may have met or exceeded T_{SAFE} provided that, at a later time, another T_{O} sample is taken and T_{O}<T_{SAFE}. In that regard, fuel monitoring 500 may allow for an individual tank to cool to below T_{SAFE} before continuing to fuel. In various embodiments, as discussed above, controller 402 may command manifold 360 to stop fueling hydrogen storage system 112 entirely in response to at least one temperature sensor meeting or exceeding T_{SAFE}.

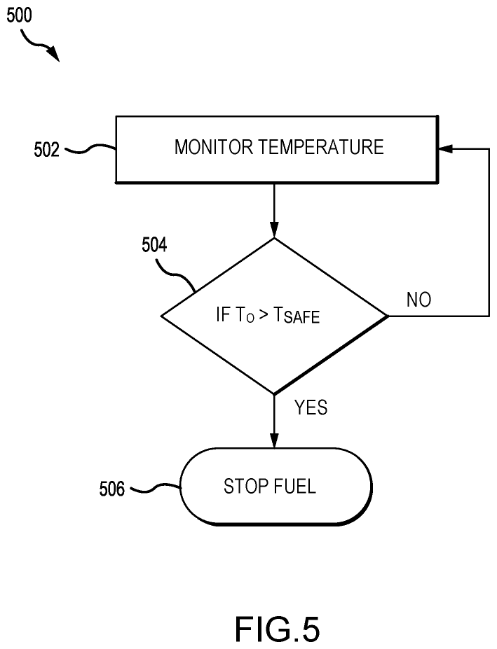

With reference to FIG. 6, pressure monitoring 600 is illustrated. At monitor pressure 602, gas monitoring system 300 monitors pressure in tanks 302, 304, 306, 308, and 310 during fueling. During fueling, hydrogen gas is conducted into tanks 302, 304, 306, 308, and 310 via plumbing system 384. A predetermined pressure, P_{SAFE}, may be selected for hydrogen gas. P_{SAFE} may be considered a pressure that is near a pressure that would create a hazardous situation for the fueling gas, such as hydrogen. P_{SAFE} may alternatively be a pressure that is near a pressure that would result in damage to one or more components of hydrogen storage system 112, for example, tanks 302, 304, 306, 308, and 310. In various embodiments, P_{SAFE} is 86.5 MPa, though it may range from 80 MPa-87 MPa. An observed pressure, Po, comprises an observed pressure from at least one of EP pressure sensors 318, 328, 338, 348, and 358.

At determination 604, a P_{O} is taken from one or more of EP pressure sensors 318, 328, 338, 348, and 358. Each P_{O} is individually compared to P_{SAFE}. Provided that each P_{O}<P_{SAFE}, monitor pressure 602 may continue at a desired rate.

If P_{O}>P_{SAFE} or if P_{O}=P_{SAFE}, stop fuel 606 occurs. In that regard, controller 402 may command, via an electronic or wireless communications pathway, to a fueling station to cease addition of hydrogen gas. In various embodiments, especially where a fueling station does not have an electronically controlled flow controller, controller 402 may command manifold 360 to stop fueling hydrogen storage system 112. In further embodiments, controller 402 may command manifold 360 to stop fueling only the tank associated with the sensor that produced the P_{O} that met or exceeded P_{SAFE}. For example, if EP pressure sensor 318 recorded a P_{O} that met or exceeded P_{SAFE}, controller 402 may command manifold 360 to cease fueling tank 302 yet continue fueling tanks 304, 306, 308, and 310. In this regard, only the tank that has met or exceeded P_{SAFE} experiences a stoppage of fueling.

After a predetermined amount of time, pressure monitoring 600 may continue, even for tanks that may have met or exceeded P_{SAFE} provided that, at a later time, another P_{O} sample is taken and P_{O}<P_{SAFE}. In that regard, pressure monitoring 600 may allow for an individual tank to reduce in pressure to below P_{SAFE} before continuing to fuel. Pressure in a tank may reduce for a variety of reasons, such as having hydrogen gas vented through vent system 387 or by a tank exchanging heat with the ambient environment to cool the tank, which would reduce internal pressure. In various embodiments, as discussed above, controller 402 may command manifold 360 to stop fueling hydrogen storage system 112 entirely in response to at least one pressure sensor meeting or exceeding P_{SAFE}.

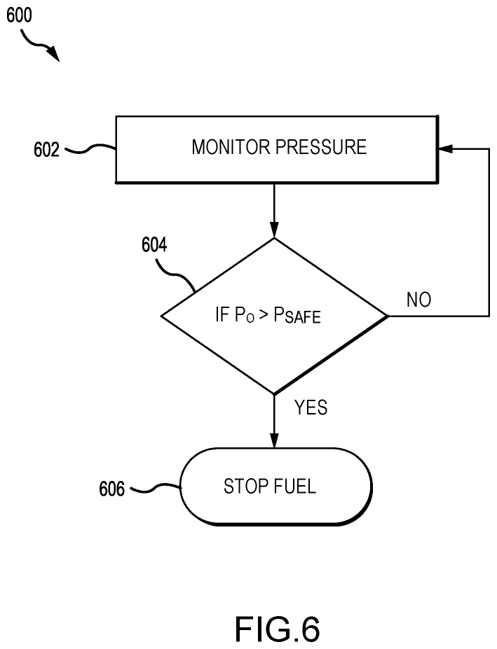

With reference to FIG. 7, sensor monitoring 700 is illustrated. At monitor plurality of temperatures 702, gas monitoring system 300 monitors temperature in tanks 302, 304, 306, 308, and 310. Monitor plurality of temperature 702 may be conducted during fueling mode. At monitor plurality of temperature 702, observed temperatures from OTV temperature sensors 314, 322, 332, 342, and 352 and EP temperature sensors 316, 326, 336, 346, and 356 may be compared. For example, each of OTV temperature sensors 314, 322, 332, 342, and 352 and EP temperature sensors 316, 326, 336, 346, and 356 may produce a temperature value in a set of temperature values.

At compare 704, the array may be analyzed to determine if one of the observed temperatures is an outlier. An outlier may be considered a value that is more or less than is expected given the other values in the set. For example, the mean, mode, and standard deviation of the set may be calculated. A predetermined threshold variance from the mean, for example, may be used to identify an outlier. The predetermined threshold variance may be from 2% to 20%, from 5% to 15%, and from 8% to 12%, but in various embodiments is 10%. In that regard, for example, at compare 704, the values from OTV temperature sensors 314, 322, 332, 342, and 352 and EP temperature sensors 316, 326, 336, 346, and 356 are averaged and the mean determined. Then, each value in the set of values is compared to see if the value is within 10% of the mean. Other methodologies for determining an outlier include setting a predetermined threshold variance from the largest observed temperature and determining any other observed temperatures that fall outside such a range.

If any outliers are identified, stop fuel 706 may be initiated by the controller 402 and an alert 708 may be sent by the controller 402 to an appropriate vehicular system and/or an off-vehicle system via wireless communications interface.

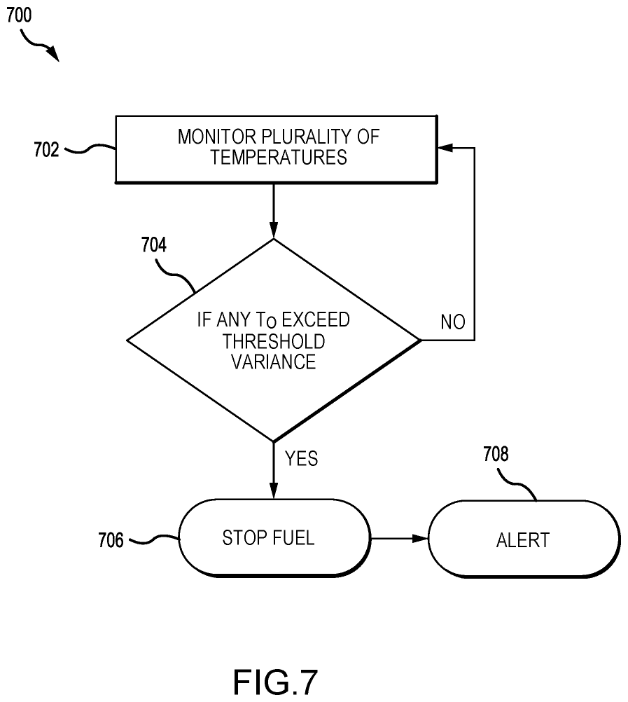

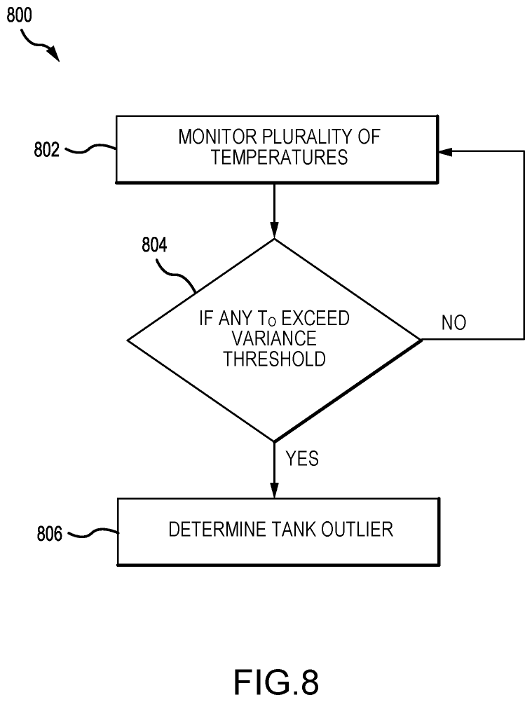

With reference to FIG. 8, sensor monitoring 800 is illustrated. At monitor plurality of temperatures 802, gas monitoring system 300 monitors temperature in tanks 302, 304, 306, 308, and 310. Monitor plurality of temperatures 802 may be conducted in various vehicular modes, including during fueling, defueling, drive mode, drive-ready mode, and while in an off mode. At monitor plurality of temperatures 802, observed temperatures from OTV temperature sensors 314, 322, 332, 342, and 352 and EP temperature sensors 316, 326, 336, 346, and 356 may be compared. For example, each of OTV temperature sensors 314, 322, 332, 342, and 352 and EP temperature sensors 316, 326, 336, 346, and 356 may produce a temperature value in a set of temperature values.

At compare 804, the array may be analyzed to determine if one of the observed temperatures is an outlier. An outlier may be considered a value that is more or less than is expected given the other values in the set. For example, the mean, mode, and standard deviation of the set may be calculated. A predetermined threshold variance from the mean, for example, may be used to identify an outlier. The predetermined threshold variance may be from 2% to 20%, from 5% to 15%, and from 8% to 12%, but in various embodiments is 10%. In that regard, for example, at compare 804, the values from OTV temperature sensors 314, 322, 332, 342, and 352 and EP temperature sensors 316, 326, 336, 346, and 356 are averaged and the mean determined. Then, each value in the set of values is compared to see if the value is within 10% of the mean. Other methodologies for determining an outlier include setting a predetermined threshold variance from the largest observed temperature and determining any other observed temperatures that fall outside such a range.

If any outliers are identified, determine tank outlier 806 may be initiated by the controller 402 and an alert may be sent by the controller 402 to an appropriate vehicular system and/or an off-vehicle system via wireless communications interface. Determine tank outlier 806 may also comprise identifying the tank that has the sensor observing the outlier. This may be performed by mapping the outlier values to the particular sensor of OTV temperature sensors 314, 322, 332, 342, and 352 and/or EP temperature sensors 316, 326, 336, 346, and 356 that produced the observed temperature. Moreover, further analysis may be performed, such as, for example, sensor fault identification method 1400 as described herein.

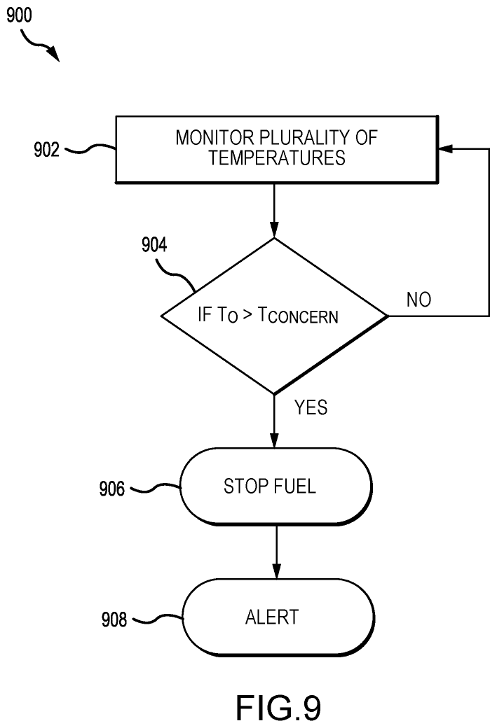

With reference to FIG. 9, fuel monitoring 900 is illustrated. At monitor plurality of temperatures 902, gas monitoring system 300 monitors temperature in tanks 302, 304, 306, 308, and 310 during fueling. During fueling, hydrogen gas is conducted into tanks 302, 304, 306, 308, and 310 via plumbing system 384. A predetermined temperature of concern, T_{CONCERN}, may be selected for hydrogen gas. T_{CONCERN} may be considered a temperature that would create a hazardous situation for the fueling gas, such as hydrogen. In that regard, T_{CONCERN} is a temperature that represents a safety concern that should be addressed urgently. T_{CONCERN} may alternatively be a temperature that is near a temperature that would result in damage to one or more components of hydrogen storage system 112, for example, tanks 302, 304, 306, 308, and 310. In various embodiments, T_{CONCERN} is 85° C., though it may range from 85° C.-87° C. An observed temperature, T_{O}, comprises an observed temperature from at least one of OTV temperature sensors 314, 322, 332, 342, and 352 and EP temperature sensors 316, 326, 336, 346, and 356.

At determination 904, a T_{O} is taken from one or more of OTV temperature sensors 314, 322, 332, 342, and 352 and EP temperature sensors 316, 326, 336, 346, and 356. Each T_{O} is individually compared to T_{CONCERN}. Provided that each T_{O}<T_{CONCERN}, monitor plurality of temperatures 902 may continue at a desired rate.

If T_{O}>T_{CONCERN} or if T_{O}=T_{CONCERN}, stop fuel 906 occurs. In that regard, controller 402 may command, via an electronic or wireless communications pathway, to a fueling station to cease addition of hydrogen gas. In various embodiments, especially where a fueling station does not have an electronically controlled flow controller, controller 402 may command one or more of OTVs 312, 320, 330, 340, and 350 to close, thus stopping fueling hydrogen storage system 112.

Moreover, at alert 908, controller 402 may transmit an alert signal to control systems 440. Control systems 440 may display such an alert on a display device in the cabin and/or transmit the alert to one or more wirelessly connected systems. Controller 402 may also transmit a command to mechanical system 430 to undertake an action to enhance safety, for example, to engage the parking brake provided the FCEV 100 is not in motion.

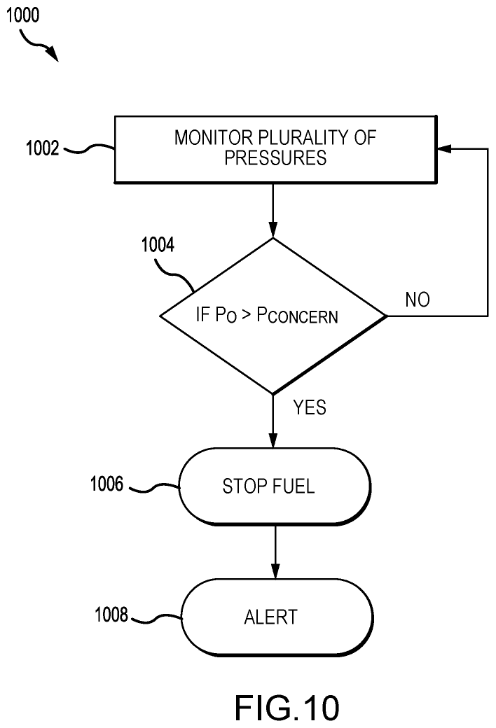

With reference to FIG. 10, pressure monitoring 1000 is illustrated. At monitor plurality of pressures 1002, gas monitoring system 300 monitors pressure in tanks 302, 304, 306, 308, and 310 during fueling. During fueling, hydrogen gas is conducted into tanks 302, 304, 306, 308, and 310 via plumbing system 384. A predetermined pressure, P_{CONCERN} may be selected for hydrogen gas. P_{CONCERN} may be considered a pressure that poses an imminent hazardous situation for the fueling gas, such as hydrogen. P_{CONCERN} may alternatively be a pressure that is near a pressure that would result in damage to one or more components of hydrogen storage system 112, for example, tanks 302, 304, 306, 308, and 310. In various embodiments, P_{CONCERN} is 87.5 MPa, though it may range from 87.5 MPa-90 MPa. An observed pressure, P_{O}, comprises an observed pressure from at least one of EP pressure sensors 318, 328, 338, 348, and 358.

At determination 1004, a P_{O} is taken from one or more of EP pressure sensors 318, 328, 338, 348, and 358. Each P_{O} is individually compared to P_{CONCERN}. Provided that each P_{O}<P_{CONCERN}, monitor plurality of pressures 1002 may continue at a desired rate.

If P_{O}>P_{SAFE} or if P_{O}=P_{CONCERN}, stop fuel 1006 occurs. In that regard, controller 402 may command, via an electronic or wireless communications pathway, to a fueling station to cease addition of hydrogen gas. In various embodiments, especially where a fueling station does not have an electronically controlled flow controller, controller 402 may command manifold 360 to stop fueling hydrogen storage system 112.

At alert 1008, controller 402 may command, via an electronic or wireless communications pathway, to a fueling station to cease addition of hydrogen gas. In various embodiments, especially where a fueling station does not have an electronically controlled flow controller, controller 402 may command one or more of OTVs 312, 320, 330, 340, and 350 to close, thus stopping fueling hydrogen storage system 112.

Moreover, at alert 1008, controller 402 may transmit an alert signal to control systems 440. Control systems 440 may display such an alert on a display device in the cabin and/or transmit the alert to one or more wirelessly connected systems. Controller 402 may also transmit a command to mechanical system 430 to undertake an action to enhance safety, to engage the parking brake provided the FCEV 100 is not in motion.

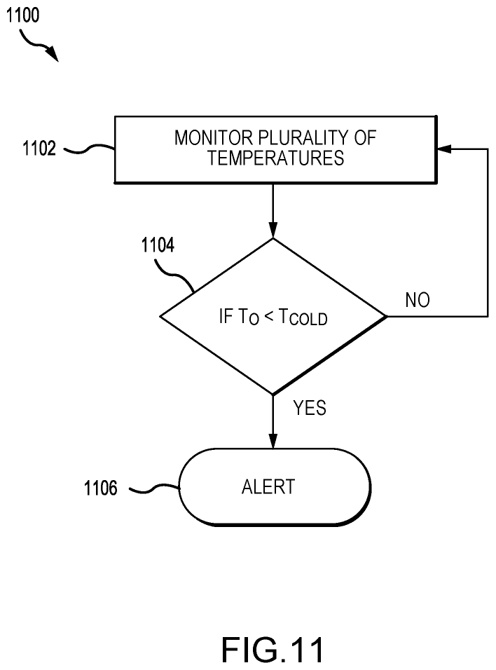

With reference to FIG. 11, fuel monitoring 1100 is illustrated. At monitor plurality of temperatures 1102, gas monitoring system 300 monitors temperature in tanks 302, 304, 306, 308, and 310 during fueling. During defueling, drive-ready, or in the off mode, hydrogen gas is stored in and/or conducted away from tanks 302, 304, 306, 308, and 310 via plumbing system 384. A predetermined temperature of concern, T_{COLD}, may be selected for hydrogen gas. T_{COLD} may be considered a temperature below which that would tend to create a hazardous situation for hydrogen gas. In that regard, T_{COLD} is a temperature that represents a safety concern that should be addressed urgently. T_{COLD} may alternatively be a temperature that is near a temperature that would result in damage to one or more components of hydrogen storage system 112, for example, tanks 302, 304, 306, 308, and 310. In various embodiments, T_{COLD} is −40° C., though it may range from −38° C.-−45° C. An observed temperature, T_{O}, comprises an observed temperature from at least one of OTV temperature sensors 314, 322, 332, 342, and 352 and EP temperature sensors 316, 326, 336, 346, and 356.

At determination 1104, a T_{O} is taken from one or more of OTV temperature sensors 314, 322, 332, 342, and 352 and EP temperature sensors 316, 326, 336, 346, and 356. Each T_{O} is individually compared to T_{COLD}. Provided that each T_{O}>T_{COLD}, monitor temperature 1102 may continue at a desired rate.

If T_{O}<T_{COLD} or if T_{O}=T_{COLD}, alert 1106 occurs. At alert 1106, controller 402 may command, via an electronic or wireless communications pathway, to a fueling station to cease addition of hydrogen gas. In various embodiments, especially where a fueling station does not have an electronically controlled flow controller, controller 402 may command one or more of OTVs 312, 320, 330, 340, and 350 to close, thus stopping fueling hydrogen storage system 112.

Moreover, at alert 1106, controller 402 may transmit an alert signal to control systems 440. Control systems 440 may display such an alert on a display device in the cabin and/or transmit the alert to one or more wirelessly connected systems. Controller 402 may also transmit a command to mechanical system 430 to undertake an action to enhance safety, to engage the parking brake provided the FCEV 100 is not in motion.

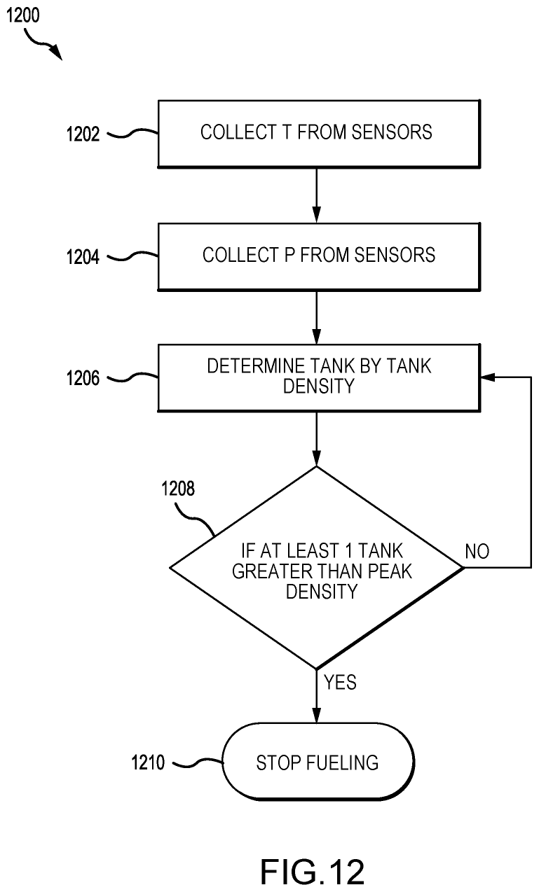

With reference to FIG. 12, density monitoring 1200 is illustrated. At collect temperature from sensors 1202, gas monitoring system 300 collects temperature observations from tanks 302, 304, 306, 308, and 310 during fueling. During fueling, hydrogen gas is conducted into tanks 302, 304, 306, 308, and 310 via plumbing system 384. Temperature observations may be taken from one or more of OTV temperature sensors 314, 322, 332, 342, and 352 and EP temperature sensors 316, 326, 336, 346, and 356. Each temperature observation is averaged together by tank, meaning that an average is taken of OTV temperature sensor 314 and EP temperature sensor 316 to obtain an average temperature of tank 302, an average of OTV temperature sensor 322 and EP temperature sensor 326 to obtain an average temperature of tank 304, an average of OTV temperature sensor 332 and EP temperature sensor 336 to obtain an average temperature of tank 306, an average of OTV temperature sensor 342 and EP temperature sensor 346 to obtain an average temperature of tank 308, and an average of OTV temperature sensor 352 and EP temperature sensor 356 to obtain an average temperature of tank 310.

At collect pressure from sensors 1204, gas monitoring system 300 collects pressure observations for tanks 302, 304, 306, 308, and 310 from EP pressure sensors 318, 328, 338, 348, and 358.

At determine tank by tank density 1206, the density of the hydrogen contained in each of tanks 302, 304, 306, 308, and 310 is calculated. Density is derived from mass divided by volume. Each of tanks 302, 304, 306, 308, and 310 are of a known volume. It is known that hydrogen gas has a molar mass of approximately 2.016 g/mol. As referenced above, the ideal gas law, PV=nRT may be used as an approximation with real gases. In that regard, density of a gas equals PM/RT, where P is the pressure, M is the molar mass, R is the ideal gas constant, and T is temperature. Given the temperature of tanks 302, 304, 306, 308, and 310, the pressure in tanks 302, 304, 306, 308, and 310, the ideal gas constant, the known volume of each of tanks 302, 304, 306, 308, and 310, and the molar mass of hydrogen gas, the density of the hydrogen gas in each of tanks 302, 304, 306, 308, and 310 may be calculated.

In determine peak density 1208, the density of the hydrogen gas in each of tanks 302, 304, 306, 308, and 310 is compared to a predetermined peak density. If the predetermined peak density is greater than each of the densities of the hydrogen gas in each of tanks 302, 304, 306, 308, and 310, further density calculations may be performed at later intervals. If at least one of the densities of the hydrogen gas in each of tanks 302, 304, 306, 308, and 310 is greater than the predetermined peak density, stop fueling 1210 occurs. In that regard, controller 402 may command, via an electronic or wireless communications pathway, to a fueling station to cease addition of hydrogen gas. In various embodiments, especially where a fueling station does not have an electronically controlled flow controller, controller 402 may command manifold 360 to stop fueling hydrogen storage system 112.

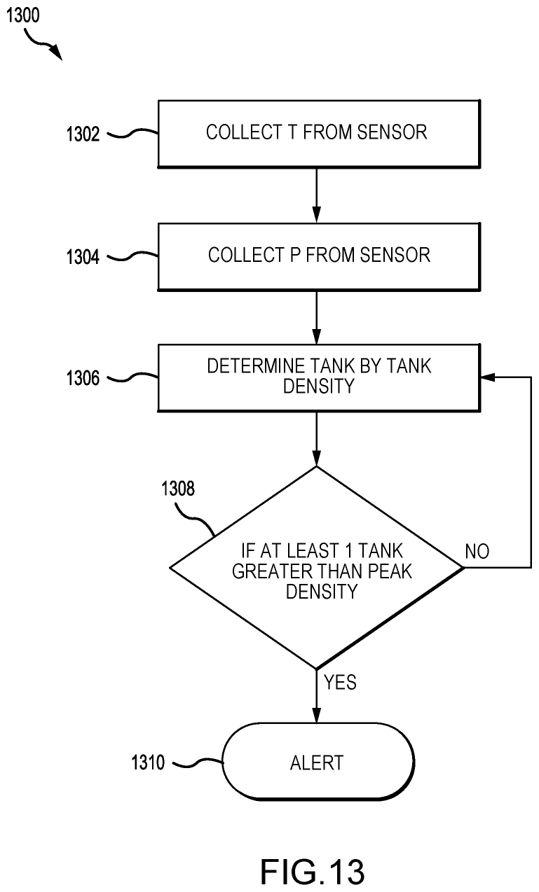

With reference to FIG. 13, density monitoring 1300 is illustrated. At collect temperature from sensors 1302, gas monitoring system 300 collects temperature observations from tanks 302, 304, 306, 308, and 310 during defueling, drive, drive-ready, or off modes. During drive, defueling, drive-ready, or in the off mode, hydrogen gas is stored in and/or conducted away from tanks 302, 304, 306, 308, and 310 via plumbing system 384. Temperature observations may be taken from one or more of OTV temperature sensors 314, 322, 332, 342, and 352 and EP temperature sensors 316, 326, 336, 346, and 356. Each temperature observation is average together by tank, meaning that an average is taken of OTV temperature sensor 314 and EP temperature sensor 316 to obtain an average temperature of tank 302, an average of OTV temperature sensor 322 and EP temperature sensor 326 to obtain an average temperature of tank 304, an average of OTV temperature sensor 332 and EP temperature sensor 336 to obtain an average temperature of tank 306, an average of OTV temperature sensor 342 and EP temperature sensor 346 to obtain an average temperature of tank 308, and an average of OTV temperature sensor 352 and EP temperature sensor 356 to obtain an average temperature of tank 310.

At collect pressure from sensors 1304, gas monitoring system 300 collects pressure observations for tanks 302, 304, 306, 308, and 310 from EP pressure sensors 318, 328, 338, 348, and 358.

At determine tank by tank density 1306, the density of the hydrogen contained in each of tanks 302, 304, 306, 308, and 310 is calculated. As discussed above, density is derived from mass divided by volume. Each of tanks 302, 304, 306, 308, and 310 are of a known volume. It is known that hydrogen gas has a molar mass of approximately 2.016 g/mol. As referenced above, the ideal gas law, PV=nRT may be used as an approximation with real gases. In that regard, density of a gas equals PM/RT, where P is the pressure, M is the molar mass, R is the ideal gas constant, and T is temperature. Given the temperature of tanks 302, 304, 306, 308, and 310, the pressure in tanks 302, 304, 306, 308, and 310, the ideal gas constant, the known volume of each of tanks 302, 304, 306, 308, and 310, and the molar mass of hydrogen gas, the density of the hydrogen gas in each of tanks 302, 304, 306, 308, and 310 may be calculated.

In determine peak density 1308, the density of the hydrogen gas in each of tanks 302, 304, 306, 308, and 310 is compared to a predetermined peak density. If the peak density is greater than each of the densities of the hydrogen gas in each of tanks 302, 304, 306, 308, and 310, further density calculations may be performed at later intervals. If the peak density is less than at least one of the densities of the hydrogen gas in each of tanks 302, 304, 306, 308, and 310, alert 1310 occurs. In that regard, controller 402 may command, via an electronic or wireless communications pathway, to another electronic system of FCEV 100 to notify that hydrogen storage system 112 has at least partially exceeded peak density. Controller 402 may take further remedial action. Further remedial actions may include commanding manifold 360 to fluidically isolate the tank that reached peak density from the other tanks in hydrogen storage system 112. Moreover, further remedial actions may include commanding one or more of OTVs 312, 320, 330, 340, and 350 to actuate and prevent any further flow into the tank that reached peak density.

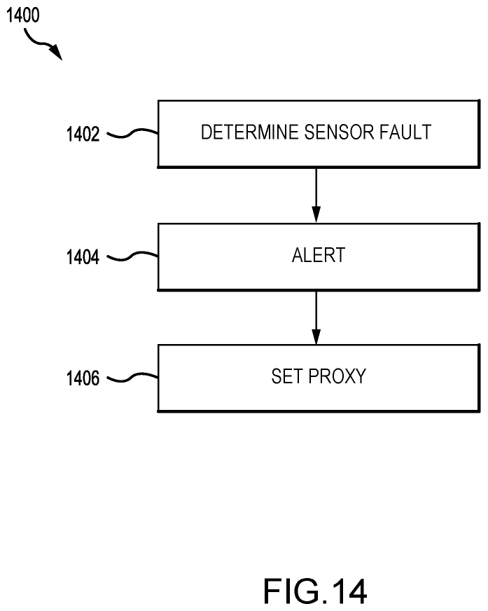

With reference to FIG. 14, sensor fault identification 1400 is illustrated. After sensor monitoring 800 is performed, one or more outlier temperature observations are identified and input into sensor fault identification 1400. At determine sensor fault 1402, the one or more outlier temperature observations are associated with one or more of tanks 302, 304, 306, 308, and 310 depending upon the temperature sensor that obtained the temperature observation. Then, each outlier temperature observation is assessed to determine if the outlier temperature observation is a multiple of the predetermined threshold variance described in sensor monitoring 800. In various embodiments, at least 1.1 to 2 times the predetermined threshold variance described in sensor monitoring 800 is used as a multiple. Any outlier temperature observations that exceed the multiple of the predetermined threshold variance is obtained and the associated tank is also obtained. Thus, a faulted sensor is identified.

Alert 1404 comprises alerting, by controller 402, of a faulted sensor. In that regard, controller 402 may command, via an electronic or wireless communications pathway, to another electronic system of FCEV 100 to report the faulted sensor. The alert may comprise an electronic message, a visual display on a display device associated with FCEV 100, a haptic response on a haptic device associated with FCEV 100, and/or other associated alerting process.

Given a faulted sensor, set proxy 1406 is implemented. If a single temperature sensor is faulted on a given tank, controller 402 may ignore the temperature observations from that sensor in any of the systems and methods described herein. In that regard, if any of OTV temperature sensors 314, 322, 332, 342, and 352 are faulted, the corresponding EP temperature sensors 316, 326, 336, 346, and 356 may be used as a proxy for the faulted sensor, and if any of EP temperature sensors 316, 326, 336, 346, and 356 are faulted, the corresponding OTV temperature sensors 314, 322, 332, 342, and 352 may be used as a proxy for the faulted sensor. If any of EP pressure sensors 318, 328, 338, 348, and 358 are faulted (as identified using a similar method to sensor monitoring 800 only with respect to pressure rather than temperature), set proxy 1406 may comprise setting an adjacent tank as a proxy. In that regard, controller 402 may substitute the pressure observations from an adjacent tank in lieu of the pressure observations from that faulted pressure sensor in any of the systems and methods described herein. Use as a proxy means that observations from one sensor will stand in for, i.e., act in lieu of, observations from the faulted sensor.

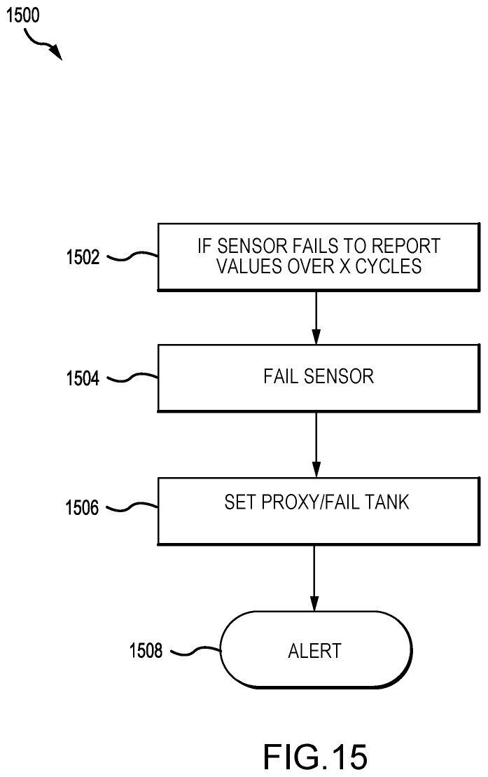

With reference to FIG. 15, sensor failure identification 1500 is illustrated. During any process described herein, it may occur that a sensor fails to report an observation (i.e., reports a null value or fails to respond at all to controller 402's request for an observation). For example, OTV temperature sensors 314, 322, 332, 342, and 352, EP pressure sensors 318, 328, 338, 348, and 358, and/or EP temperature sensors 316, 326, 336, 346, and 356 may fail to report an observation at all in response to controller 402 sampling the sensor (i.e., requesting an observation). Such a failure may be the result of a transient malfunction. However, such a failure may be the result of a connectivity issue, a mechanical issue, and/or an issue with the sensor itself. At determine sensor failure 1502, the one or more observations that fail (i.e., are not reported within a timeout period or reported as null) to be reported are aggregated by sensor. In that regard, at least one of OTV temperature sensors 314, 322, 332, 342, and 352, EP pressure sensors 318, 328, 338, 348, and 358, and/or EP temperature sensors 316, 326, 336, 346, and 356 is identified as having failed to report an observation at a given time (e.g., T_{initFail}) and assigned to a group for repolling, namely, Gᵣₑₜₑₛₜ. At a predetermined interval after such identification (e.g., at T_{secondFail}, which occurs temporally after T_{initFail}), it is determined whether the one or more sensors that have failed to report an observation (Gᵣₑₜₑₛₜ). Sensors in Gᵣₑₜₑₛₜ that fail to report an observation at T_{secondFail} are assigned to a failed group, G_{Fail}.

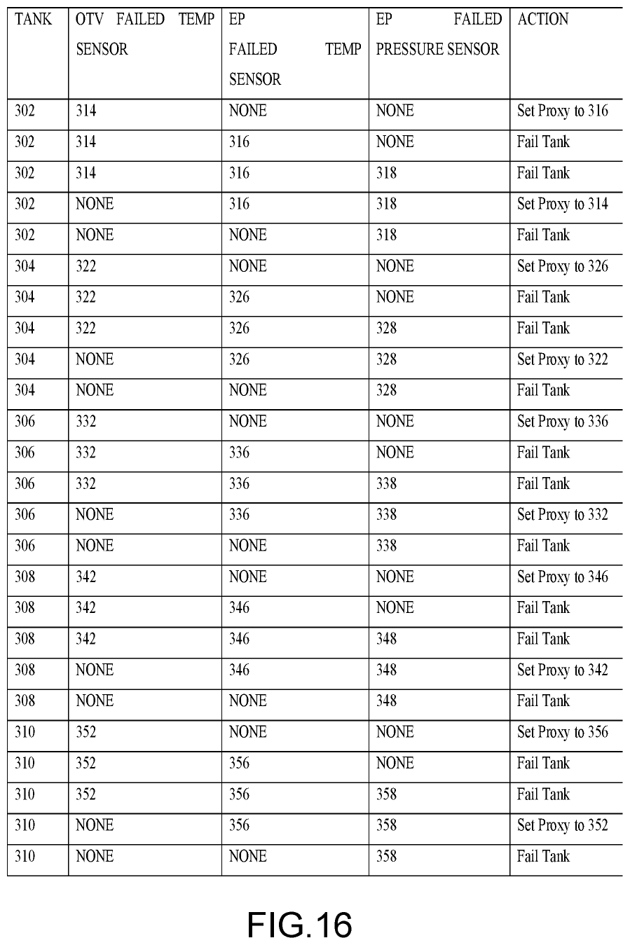

G_{Fail} is sent to fail sensor 1504. At fail sensor 1504, the sensors in Grad are associated with one or more of tanks 302, 304, 306, 308, and 310. Then, the sensors in Grad are overlayed with the associated tanks 302, 304, 306, 308, and 310. Each tank is then assessed to determine what action should to set proxy/fail tank 1506. Where no tanks have failed sensors, no further action is taken. The overlay map of sensors in G_{Fail} associated with the given tank is given in FIG. 16.

The action from FIG. 16 is sent to set proxy/fail tank 1506. Here, controller 402 takes the respective action indicated. For example, controller 402 may set a proxy where indicated. Controller 402 may use an OTV temperature sensor where an EP temperature sensor has failed and an EP temperature sensor where an OTV temperature sensor has failed. Where an EP pressure sensor has failed, it may be beneficial to fail the tank. In that regard, controller 402 may command the OTV of the failed tank to actuate to prevent hydrogen gas from flowing in or out the failed tank. Moreover, controller 402 may command manifold 360 to prevent fueling from filling the failed tank. In that regard, controller 402 isolates the failed tank from use, which reduces the overall fuel capacity of hydrogen storage system 112 but allows for the remaining tanks to continue in operation and prevents failure of the entire hydrogen storage system 112.

Alert 1508 comprises alerting, by controller 402, of a failed tank. In that regard, controller 402 may command, via an electronic or wireless communications pathway, to another electronic system of FCEV 100 to report the failed tank. The alert may comprise an electronic message, a visual display on a display device associated with FCEV 100, a haptic response on a haptic device associated with FCEV 100, and/or other associated alerting process. The alert may be used to adjust overall expected range and/or an alert that mechanical maintenance is needed to restore hydrogen storage system 112 to full operational capacity.

Given a faulted sensor, set proxy 1406 is implemented. If a single temperature sensor is faulted on a given tank, controller 402 may ignore the temperature observations from that sensor in any of the systems and methods described herein. In that regard, if any of OTV temperature sensors 314, 322, 332, 342, and 352 are faulted, the corresponding EP temperature sensors 316, 326, 336, 346, and 356 may be used as a proxy for the faulted sensor, and vice versa. If any of EP pressure sensors 318, 328, 338, 348, and 358 are faulted, set proxy 1406 may comprise setting an adjacent tank as a proxy. In that regard, controller 402 may substitute the pressure observations from an adjacent tank in lieu of the pressure observations from that faulted pressure sensor in any of the systems and methods described herein.

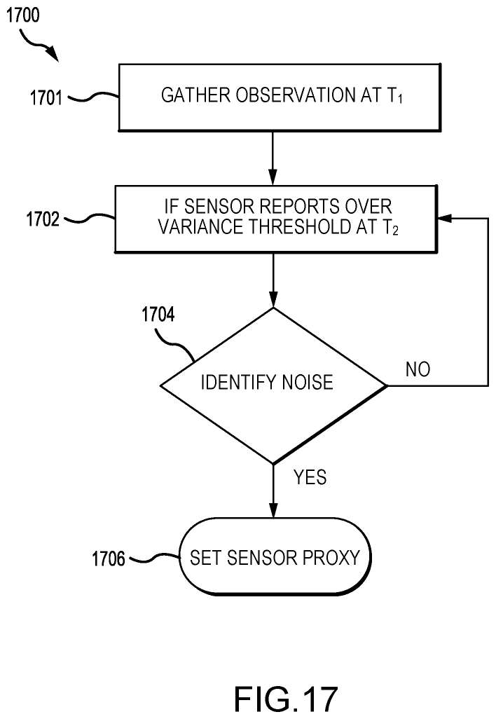

With reference to FIG. 17, sensor monitoring 1700 is illustrated. At monitor plurality of sensors 1701, gas monitoring system 300 monitors temperature and pressure in tanks 302, 304, 306, 308, and 310 at a first time (T₁). Monitor plurality of sensors 1701 may be conducted in drive mode, drive-ready mode, and while in off mode. At monitor plurality of sensors 1701, observed temperatures from OTV temperature sensors 314, 322, 332, 342, and 352, EP temperature sensors 316, 326, 336, 346, and 356, and EP pressure sensors 318, 328, 338, 348, and 358 may be gathered. For example, each of OTV temperature sensors 314, 322, 332, 342, and 352, EP temperature sensors 316, 326, 336, 346, and 356, and EP pressure sensors 318, 328, 338, 348, and 358 may produce values in an array of temperature and pressure values.

At monitor plurality of sensors 1702, gas monitoring system 300 monitors temperature and pressure in tanks 302, 304, 306, 308, and 310 at a second time (T₂). Monitor plurality of sensors 1702 may be conducted in drive mode, drive-ready mode, and while in off mode. At monitor plurality of sensors 1702, observed temperatures from OTV temperature sensors 314, 322, 332, 342, and 352, EP temperature sensors 316, 326, 336, 346, and 356, and EP pressure sensors 318, 328, 338, 348, and 358 may be gathered. For example, each of OTV temperature sensors 314, 322, 332, 342, and 352, EP temperature sensors 316, 326, 336, 346, and 356, and EP pressure sensors 318, 328, 338, 348, and 358 may produce values in an array of temperature and pressure values representing observation at T₂. It is understood that additional sampling may be performed to produce arrays of values at further times (T₃, T₄, T₅, etc.).

At identify noise 1704, the array may be analyzed to determine if one of the observed values has changed significantly. In the drive, drive-ready, and off modes, temperature and pressure in tanks 302, 304, 306, 308, and 310 should not change significantly provided a relatively small difference in T₁ and T₂. The difference between T₁ and T₂ may be, in various embodiments, from 0.1 ms to 30 s, 10 ms to 15 s, and is to 5 s, though other ranges are contemplated herein. A variance threshold that indicates a significant change may be from 8% to 20%, from 9% to 15%, and about 10% from the previous value. In that regard each observed value from each sensor is at T₁ is subtracted from T₂ and the absolute value is taken and converted into a percentage change. If the absolute value exceeds the variance threshold, the sensor is identified as unreliable.

If any unreliable sensors are identified, set sensor proxy 1706 may be initiated by the controller 402. If a single temperature sensor is unreliable on a given tank, controller 402 may ignore the temperature observations from that sensor in any of the systems and methods described herein. In that regard, if any of OTV temperature sensors 314, 322, 332, 342, and 352 are unreliable, the corresponding EP temperature sensors 316, 326, 336, 346, and 356 may be used as a proxy for the unreliable sensor, and if any of EP temperature sensors 316, 326, 336, 346, and 356 are unreliable, the corresponding OTV temperature sensors 314, 322, 332, 342, and 352 may be used as a proxy for the unreliable sensor. If any of EP pressure sensors 318, 328, 338, 348, and 358 are unreliable, set proxy 1406 may comprise setting an adjacent tank as a proxy. In that regard, controller 402 may substitute the pressure observations from an adjacent tank in lieu of the pressure observations from that faulted pressure sensor in any of the systems and methods described herein. Use as a proxy here, as above, means that observations from one sensor will stand in for, i.e., act in lieu of, observations from the faulted sensor. Moreover, controller 402 may transmit an alert to an appropriate vehicular system and/or an off-vehicle system via wireless communications interface.

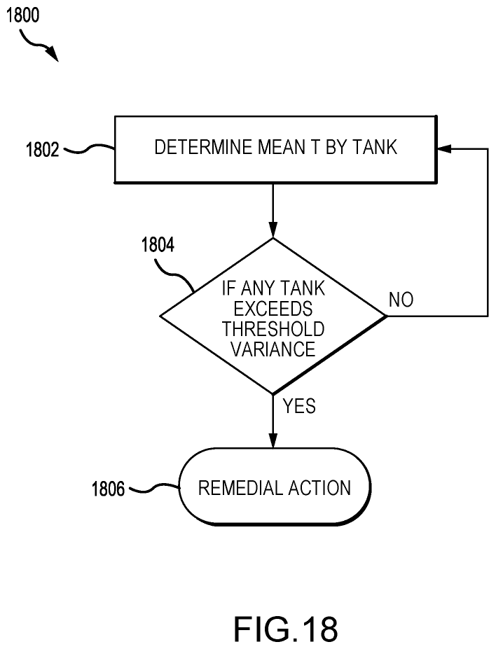

With reference to FIG. 18, sensor monitoring 18000 is illustrated. At determine mean by tank 1802, gas monitoring system 300 monitors temperature in tanks 302, 304, 306, 308, and 310. Determine mean by tank 1802 may be conducted during fueling, defueling, drive, drive-ready, and off modes. At determine mean by tank 1802, observed temperatures from OTV temperature sensors 314, 322, 332, 342, and 352 and EP temperature sensors 316, 326, 336, 346, and 356 are averaged (i.e., arithmetic mean) together by tank. In that regard, the temperature observation from OTV temperature sensors 314 is averaged with the temperature observation from EP temperature sensor 316 to yield an average temperature for tank 302, the temperature observation from OTV temperature sensors 322 is averaged with the temperature observation from EP temperature sensor 326 to yield an average temperature for tank 304, the temperature observation from OTV temperature sensors 332 is averaged with the temperature observation from EP temperature sensor 336 to yield an average temperature for tank 306, the temperature observation from OTV temperature sensors 342 is averaged with the temperature observation from EP temperature sensor 346 to yield an average temperature for tank 308 and, the temperature observation from OTV temperature sensors 356 is averaged with the temperature observation from EP temperature sensor 356 to yield an average temperature for tank 310. In this manner, an averaged temperature observation is obtained for each of tanks 302, 304, 306, 308, and 310. At least one of the arithmetic mean and mode are taken from the set of averaged temperature observations of each tank to obtain a composite temperature of the tanks. Then, each averaged temperature observation is compared to the composite temperature.

At tank exceeds threshold variance 1804, the array may be analyzed to determine if one of the average temperature observations exceeds a predetermined threshold variance. The predetermined threshold variance may be from 2% to 20% of the composite temperature, from 5% to 15% of the composite temperature, and from 8% to 12% of the composite temperature, but in various embodiments is 10% of the composite temperature. In that regard, for example, at tank exceeds threshold variance 1804, the average temperature observations are compared to the composite temperature, and it is determined whether any of the average temperature observations exceed the predetermined threshold variance. If none of the average temperature observations exceed the threshold variance, determine mean by tank 1802 may be repeated again at various intervals. If any of the average temperature observations exceed the threshold variance, the tank associated with the average temperature observation that exceeds the threshold variance is identified as an unbalanced temperature tank and sent to remedial action 1806.

At remedial action 1806, controller 402 may take remedial action in response to identification of at least one unbalanced temperature tank. Having one unbalanced temperature tank may indicate a variety of issues. For example, there may be a mechanical issue with the unbalanced temperature tank or there may be an external heat source adjacent to the unbalanced temperature tank that is driving the unbalanced temperature. In that regard, in fueling mode, controller 402 may command to stop fuel and an alert may be sent by the controller 402 to an appropriate vehicular system and/or an off-vehicle system via wireless communications interface. Controller 402 may command, via an electronic or wireless communications pathway, to a fueling station to cease addition of hydrogen gas. In various embodiments, especially where a fueling station does not have an electronically controlled flow controller, controller 402 may command manifold 360 to stop fueling hydrogen storage system 112. Moreover, an alert may be sent by the controller 402 to an appropriate vehicular system and/or an off-vehicle system via wireless communications interface.

Controller 402 may also set the unbalanced tank to a failed status. In various embodiments, in drive mode or drive-ready mode, controller 402 may isolate the failed tank from use, which reduces the overall fuel capacity of hydrogen storage system 112 but allows for the remaining tanks to continue in operation and prevents failure of the entire hydrogen storage system 112. Controller 402 may adjust the range of the FCEV 100 accordingly, and such notification may be sent to a display device and/or a haptic feedback device. In various embodiments, controller 402 commands hydrogen storage system 112 to close valves to fluidically isolate the failed tank.

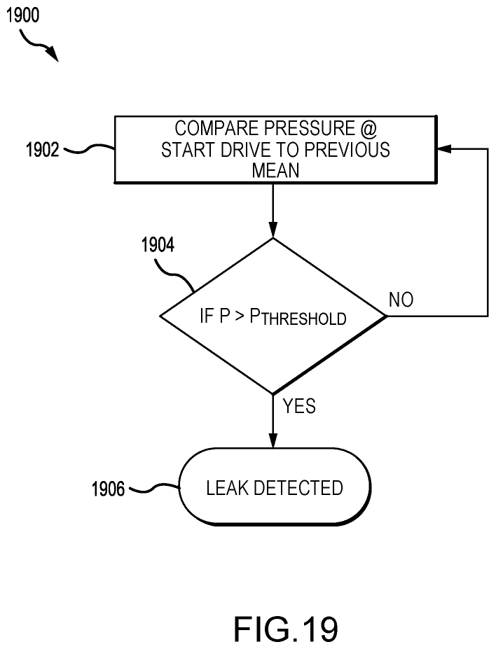

With reference to FIG. 19, pressure monitoring 1900 is illustrated. Previous to compare pressure at start drive 1902, controller 402 samples each of EP pressure sensors 318, 328, 338, 348, and 358 to obtain pressure observations and calculated at least one of an arithmetic mean or a mode controller 402 to yield a last known composite pressure. At compare pressure at start drive 1902, gas monitoring system 300 monitors pressure in tanks 302, 304, 306, 308, and 310 via EP pressure sensors 318, 328, 338, 348, and 358 at the start of drive-ready mode. Controller 402 samples each of EP pressure sensors 318, 328, 338, 348, and 358 to obtain pressure observations and calculates at least one of an arithmetic mean or a mode to yield a current composite pressure.

At compare 1904, the current composite pressure is compared to the last known composite pressure. In particular, for example, current composite pressure may be subtracted from the last known composite pressure and the absolute value taken of the result. The absolute value of the result may be compared to the last known composite pressure. A predetermined variance threshold may be used in this comparison. A predetermined variance threshold that indicates a significant change may be from 8% to 20%, from 9% to 15%, and about 10% from the previous value. If the absolute value of the result does not exceed the predetermined variance threshold of the last known composite pressure, further comparisons may be performed at a later time.

If the absolute value of the result exceeds the predetermined variance threshold of the last known composite pressure, leak detection 1906 is alerted.

At leak detection 1906, controller 402 may determine that a leak in hydrogen storage system 112 may have occurred or is occurring. Controller 402 may take remedial action in response to identification of such leak. A leak in hydrogen storage system 112 could be from one or more of tanks 302, 304, 306, 308, and 310 or could arise from plumbing system 384, among other places. In that regard, controller 402 may command that FCEV 100 not proceed to continue in drive-ready mode and an alert may be sent by the controller 402 to an appropriate vehicular system and/or an off-vehicle system via wireless communications interface. Controller 402 may command, via an electronic or wireless communications pathway, one or more mechanical systems in FCEV 100 to lock or engage. For example, controller 402 may command a parking brake of FCEV 100 to engage in response to finding a leak.

Controller 402 may conduct other diagnostic methods to isolate or mitigate the leak. For example, controller 402 may sample EP pressure sensors 318, 328, 338, 348, and 358 and compare to previously stored values for each sensor. The difference of each current value to the last known value may be used to compare against the predetermined variance threshold. Any tanks having pressure decreases that exceed the predetermined variance threshold may be identified as leaking. Controller 402 may then command that manifold 360 or any other portion of hydrogen storage system 112 to fluidically isolate a tank that has been identified as leaking. In that regard, one or more valves of plumbing system 384 may be closed in response to a command from controller 402.

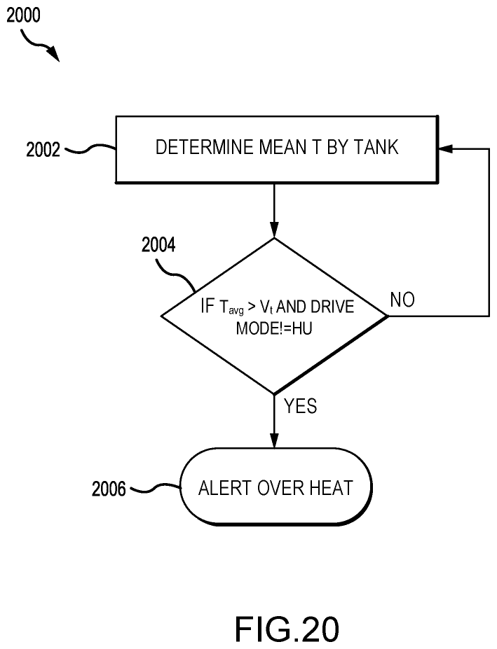

With reference to FIG. 20, ambient temperature comparison 2000 is illustrated. At determine mean by tank 2002, gas monitoring system 300 monitors temperature in tanks 302, 304, 306, 308, and 310. Determine mean by tank 2002 may be conducted during fueling, defueling, drive, drive-ready, and off modes. At determine mean by tank 2002, observed temperatures from OTV temperature sensors 314, 322, 332, 342, and 352 and EP temperature sensors 316, 326, 336, 346, and 356 are averaged (i.e., arithmetic mean) together by tank. In that regard, the temperature observation from OTV temperature sensors 314 is averaged with the temperature observation from EP temperature sensor 316 to yield an average temperature for tank 302, the temperature observation from OTV temperature sensors 322 is averaged with the temperature observation from EP temperature sensor 326 to yield an average temperature for tank 304, the temperature observation from OTV temperature sensors 332 is averaged with the temperature observation from EP temperature sensor 336 to yield an average temperature for tank 306, the temperature observation from OTV temperature sensors 342 is averaged with the temperature observation from EP temperature sensor 346 to yield an average temperature for tank 308 and, the temperature observation from OTV temperature sensors 356 is averaged with the temperature observation from EP temperature sensor 356 to yield an average temperature for tank 310. In this manner, an average temperature observation (T_{avg}) is obtained for each of tanks 302, 304, 306, 308, and 310. At least one of the arithmetic mean and mode are taken from the set of averaged temperature observations of each tank to obtain a composite temperature of the tanks. Then, each averaged temperature observation is compared to the composite temperature.

At compare average temperature and drive mode 2004, each average temperature for each tank is compared to the ambient temperature. The ambient temperature may be received by controller 402 from another system onboard FCEV 100, from a remote system, and/or from a sensor in communication with controller 402. Controller 402 may then analyze to determine whether one of the average temperatures exceeds a predetermined threshold variance (Vₜ) from the ambient temperature. The predetermined threshold variance may be from 2% to 20% of the ambient temperature, from 5% to 15% of the ambient temperature, and from 8% to 12% of the ambient temperature, but in various embodiments is 10% of the ambient temperature. In that regard, for example, at compare average temperature and drive mode 2004, the average temperature observations are compared to the ambient temperature, and it is determined whether any of the average temperature observations exceed the predetermined threshold variance from the ambient temperature. If none of the average temperature observations exceed the predetermined threshold variance, determine mean by tank 2002 may be repeated again at various intervals. If any of the average temperature observations exceed the predetermined threshold variance, the tank associated with the average temperature observation that exceeds the predetermined threshold variance is identified as a potentially overheated tank. Then, controller 402 determines if the FCEV 100 is in drive mode and, if so, is there is a hard use condition (HU). A hard use condition may be any condition that involves FCEV 100 outputting a high amount of energy. For example, if FCEV is traveling on a hill with a grade greater than 2% and/or FCEV 100 is traveling through an ambient environment that exceeds 100° F. If a hard use condition is identified, controller 402 may take no further action. However, if a hard use condition is not present, controller 402 may proceed to alert over heat 2006.

At alert over heat 2006, controller 402 may take remedial action in response to identification of an overheated tank. Having one overheated tank may indicate a variety of issues. For example, there may be a mechanical issue with the overheated tank or there may be an external heat source adjacent to the unbalanced temperature tank that is driving the high temperature. An alert may be sent by the controller 402 to an appropriate vehicular system and/or an off-vehicle system via wireless communications interface. Controller 402 may also set the overheated tank to a failed status. In various embodiments, in drive mode or drive-ready mode, controller 402 may isolate the failed tank from use, which reduces the overall fuel capacity of hydrogen storage system 112 but allows for the remaining tanks to continue in operation and prevents failure of the entire hydrogen storage system 112. Controller 402 may adjust the range of the FCEV 100 accordingly, and such notification may be sent to a display device and/or a haptic feedback device. In various embodiments, controller 402 commands hydrogen storage system 112 to close valves to fluidically isolate the failed tank.

If any unreliable sensors are identified, set sensor proxy 1706 may be initiated by the controller 402. If a single temperature sensor is unreliable on a given tank, controller 402 may ignore the temperature observations from that sensor in any of the systems and methods described herein. In that regard, if any of OTV temperature sensors 314, 322, 332, 342, and 352 are unreliable, the corresponding EP temperature sensors 316, 326, 336, 346, and 356 may be used as a proxy for the unreliable sensor, and if any of EP temperature sensors 316, 326, 336, 346, and 356 are unreliable, the corresponding OTV temperature sensors 314, 322, 332, 342, and 352 may be used as a proxy for the unreliable sensor. If any of EP pressure sensors 318, 328, 338, 348, and 358 are unreliable, set proxy 1406 may comprise setting an adjacent tank as a proxy. In that regard, controller 402 may substitute the pressure observations from an adjacent tank in lieu of the pressure observations from that faulted pressure sensor in any of the systems and methods described herein. Use as a proxy here, as above, means that observations from one sensor will stand in for, i.e., act in lieu of, observations from the faulted sensor. Moreover, controller 402 may transmit an alert to an appropriate vehicular system and/or an off-vehicle system via wireless communications interface.

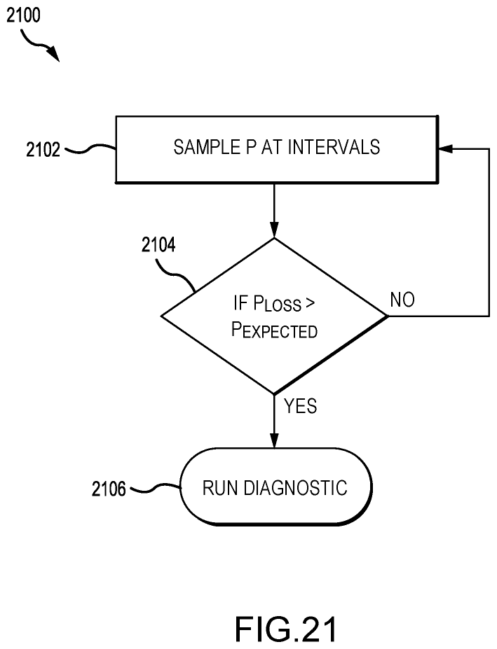

With reference to FIG. 21, pressure monitoring 2100 is illustrated. At sample pressure monitoring 2102, gas monitoring system 300 monitors pressure in tanks 302, 304, 306, 308, and 310 via EP pressure sensors 318, 328, 338, 348, and 358. Sample pressure at intervals 2102 may be performed in drive mode and/or drive-ready mode. Controller 402 samples each of EP pressure sensors 318, 328, 338, 348, and 358 to obtain pressure observations and calculates at least one of an arithmetic mean or a mode to yield a Pi composite pressure at time T₁. This sampling of pressure in tanks 302, 304, 306, 308, and 310 via EP pressure sensors 318, 328, 338, 348, and 358 then repeats at intervals at times T₂ to Tₙ, where n is the number of intervals. In this manner, a number of Pₙ composite pressure composite pressures are obtained over time Tₙ. The intervals may range from 1 ms to 60 min, 1 s to 30 min, 1 min to 10 min, and 2 min to 8 min.

At compare 2104, each of Pₙ composite pressures is compared to one another. In drive mode, for example, it may be expected that the composite pressure drops as the fuel cell operates. In that regard, it is expected that Pₙ<Pₙ₋₁. However, a pressure drop that is too large over a short period of time may indicate a leak or other issue. Thus, the Pₙ composite pressures are compared to one another. A predetermined variance threshold may be used to compare Pₙ composite pressure and Pₙ₋₁ composite pressure. A predetermined variance threshold that indicates a significant change may be from 8% to 20%, from 9% to 15%, and about 10% from the previous value. For example, the Pₙ composite pressure may be subtracted from the Pₙ₋₁ composite pressure and the absolute value taken of the result and converted into a percentage change. If the absolute value of the result does not exceed the predetermined variance threshold, further comparisons may be performed at a later time.

If the absolute value of the result exceeds the predetermined variance threshold, run diagnostic 2106 is initiated. At run diagnostic 2106, controller 402 may determine that a leak in hydrogen storage system 112 may have occurred or is occurring. Controller 402 may conduct diagnostics to determine if issues are present. For example, controller 402 may run diagnostic self-test protocols on one or more valves of hydrogen storage system 112. These protocols may reveal a damaged or otherwise compromised valve. Further, an alert may be sent by the controller 402 to an appropriate vehicular system and/or an off-vehicle system via wireless communications interface. Controller 402 may command, via an electronic or wireless communications pathway, one or more mechanical systems in FCEV 100 to lock or engage. For example, controller 402 may command a parking brake of FCEV 100 to engage in response to finding a leak.

Controller 402 may conduct other diagnostic methods to isolate or mitigate the leak. For example, controller 402 may sample EP pressure sensors 318, 328, 338, 348, and 358 and compare to previously stored values for each sensor. The difference of each current value to a last known value may be used to compare against the predetermined variance threshold. Any tanks having pressure decreases that exceed the predetermined variance threshold may be identified as leaking. Controller 402 may then command that manifold 360 or any other portion of hydrogen storage system 112 to fluidically isolate a tank that has been identified as leaking. In that regard, one or more valves of plumbing system 384 may be closed in response to a command from controller 402.

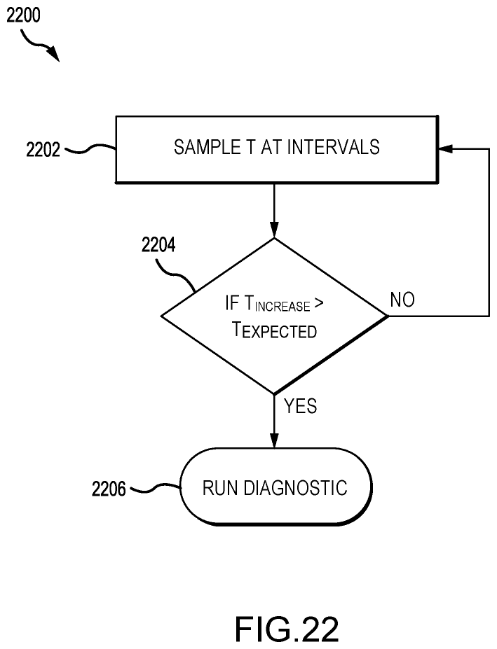

With reference to FIG. 22, temperature monitoring 2200 is illustrated. At sample temperature monitoring 2202, gas monitoring system 300 monitors temperature in tanks 302, 304, 306, 308, and 310 via OTV temperature sensors 314, 322, 332, 342, and 352 and EP temperature sensors 316, 326, 336, 346, and 356. Sample temperature at intervals 2202 may be performed in drive mode and/or drive-ready mode. Controller 402 samples each of OTV temperature sensors 314, 322, 332, 342, and 352 and EP temperature sensors 316, 326, 336, 346, and 356 to obtain temperature observations. Controller 402 then obtains at least one of an arithmetic mean or a mode for associated with each tank. In that regard, an at least one of an arithmetic mean or a mode is taken from OTV temperature sensor 314 and EP temperature sensor 316, an at least one of an arithmetic mean or a mode is taken from OTV temperature sensor 322 and EP temperature sensor 326, an at least one of an arithmetic mean or a mode is taken from OTV temperature sensor 332 and EP temperature sensor 336, an at least one of an arithmetic mean or a mode is taken from OTV temperature sensor 342 and EP temperature sensor 346, and an at least one of an arithmetic mean or a mode is taken from OTV temperature sensor 352 and EP temperature sensor 356. Controller 402 then calculates at least one of an arithmetic mean or a mode of these values to yield a Tempi composite temperature at time T₁. This sampling of temperature in tanks 302, 304, 306, 308, and 310 then repeats at intervals at times T₂ to Tₙ, where n is the number of intervals. In this manner, a number of Tempₙ composite pressure composite pressures are obtained over time Tₙ. The intervals may range from 1 ms to 60 min, 1 s to 30 min, 1 min to 10 min, and 2 min to 8 min.

At compare 2204, each of Tempₙ composite pressures is compared to one another. In drive mode, for example, it may be expected that the composite temperature remains relatively constant, absent a hard use condition or a significant change in ambient environment temperature (e.g., as would occur where ascending/descending from an elevation). Composite temperature may also rise during discharge of hydrogen gas due to the negative Joule-Thompson coefficient of hydrogen gas. In that regard, it is expected that Tempₙ is slightly above or below Tempₙ₋₁. However, a temperature increase (T_{Increase}) that is too large over a short period of time may indicate a malfunction or potentially hazardous condition. Thus, the Tempₙ composite temperatures are compared to one another. A predetermined variance threshold (T_{Expected}) may be used to compare Tempₙ temperature pressure and Tempₙ₋₁ composite temperature. A predetermined variance threshold that indicates a significant change may be from 8% to 20%, from 9% to 15%, and about 10% from the previous value. For example, the Tempₙ composite temperature may be subtracted from the Tempₙ₋₁ composite temperature and the absolute value taken of the result and converted into a percentage change. If the absolute value of the result does not exceed the predetermined variance threshold, further comparisons may be performed at a later time.

If the absolute value of the result exceeds the predetermined variance threshold, run diagnostic 2206 is initiated.

At run diagnostic 2206, controller 402 may conduct diagnostics to determine if issues are present. For example, controller 402 may determine if a hard use condition is present by receiving a hard use condition status from another system of FCEV 100. If a hard use condition is present, Controller 402 may further receive an ambient temperature reading from another system of FCEV 100. If controller 402 finds that a hard use condition is present, and/or the ambient temperature is commensurate with Tempₙ, controller 402 may conclude that no issues are present. However, if controller 402 finds that a hard use condition is not present, and/or the ambient temperature is considerably lower than Tempₙ (e.g., 20% lower than Tempₙ), controller 402 may run diagnostic additional self-test protocols related to temperature, including those disclosed herein. Controller 402, upon finding an issue, may open one or more valves of hydrogen storage system 112. These protocols may reveal send an alert to an appropriate vehicular system and/or an off-vehicle system via wireless communications interface. Controller 402 may command, via an electronic or wireless communications pathway, one or more mechanical systems in FCEV 100 to lock or engage. For example, controller 402 may command a parking brake of FCEV 100 to engage in response to finding a leak. Controller 402 may then command that manifold 360 or any other portion of hydrogen storage system 112 to fluidically isolate a tank that has been identified as leaking. In that regard, one or more valves of plumbing system 384 may be closed in response to a command from controller 402.

Any of the systems and methods disclosed herein may be implemented with varying combinations of hardware, software, communications and/or networking interfaces, and various mechanical machinery including valve actuators, mechanical actuators, display devices, haptic feedback devices, and other hardware capable of receiving a command and converting electrical energy, in response to said command, into mechanical motion.

Computer programs (also referred to as computer control logic) are stored in main memory and/or secondary memory. Computer programs may also be received via communications interface. These computer program instructions may be loaded onto a general purpose computer, special purpose computer, controller, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer, controller, or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

In various embodiments, software may be stored in a computer program product and loaded into a computer system using a removable storage drive, hard disk drive, or communications interface. The control logic (software), when executed by the processor or controller, causes the processor or controller to perform the functions of various embodiments as described herein. In various embodiments, hardware components may take the form of application specific integrated circuits (ASICs). Implementation of the hardware so as to perform the functions described herein will be apparent to persons skilled in the relevant art(s).

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment (e.g., an internet-based driving command system), an entirely hardware embodiment, or an embodiment combining aspects of the internet, software, and hardware. Furthermore, the system may take the form of a computer program product on a computer-readable storage medium having computer-readable program code means embodied in the storage medium. Any suitable computer-readable storage medium may be utilized, including hard disks, solid state storage media, CD-ROM, BLU-RAY DISC®, optical storage devices, magnetic storage devices, and/or the like.

The system and method may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT®, JAVASCRIPT® Object Notation (JSON), VBScript, Macromedia COLD FUSION, COBOL, MICROSOFT® company's Active Server Pages, assembly, PERL®, PHP, awk, PYTHON®, Visual Basic, SQL Stored Procedures, PL/SQL, any UNIX® shell script, and extensible markup language (XML) with the various algorithms being implemented with any combination of data structures, objects, processes, routines or other programming elements. Further, it should be noted that the system may employ any number of techniques for data transmission, signaling, data processing, network control, and the like. Still further, the system could be used to detect or prevent security issues with a client-side scripting language, such as JAVASCRIPT®, VBScript, or the like.

The system and method are described herein with reference to screen shots, block diagrams and flowchart illustrations of methods, apparatus, and computer program products according to various embodiments. It will be understood that each functional block of the block diagrams and the flowchart illustrations, and combinations of functional blocks in the block diagrams and flowchart illustrations, respectively, can be implemented by computer program instructions.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching may be used throughout the figures to denote different parts but not necessarily to denote the same or different materials.

Methods, systems, and articles are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A hydrogen storage system for a fuel cell electric vehicle (FCEV), comprising:
a controller in electronic communication with a first tank and a second tank, the first tank having a first tank on tank valve (OTV) temperature sensor and the second tank having a second tank OTV temperature sensor; and
a non-transitory computer-readable storage medium in electronic communication with the controller, having instructions stored thereon that, in response to execution by the controller, cause the controller to perform operations comprising:
receiving, by the controller, a first temperature from the first tank OTV temperature sensor;
receiving, by the controller, a second temperature from the second tank OTV temperature sensor;
determining, by the controller, whether the first temperature is at least one of greater than or equal to a predetermined temperature;
determining, by the controller, whether the second temperature is at least one of greater than or equal to the predetermined temperature;
in response to finding that at least one of the first temperature or the second temperature is at least one of greater than or equal to the predetermined temperature, transmitting, by the controller, a stop fuel command.

2. The hydrogen storage system of claim 1, wherein the controller transmits the stop fuel command to an electronically controlled flow controller of a fueling station.

3. The hydrogen storage system of claim 1, wherein the hydrogen storage system further comprises a regulator in electronic communication with the controller.

4. The hydrogen storage system of claim 3, wherein the instructions further comprise transmitting, by the controller, the stop fuel command to the regulator.

5. The hydrogen storage system of claim 4, further comprising a plumbing system placing the regulator in fluid communication with the first tank and the second tank.

6. The hydrogen storage system of claim 5, wherein the regulator actuates to fluidically isolate the first tank from the second tank in response to the stop fuel command.

7. The hydrogen storage system of claim 6, wherein the instructions further comprise:
waiting, by the controller, for a time interval between a first time and a second time;
determining, at the second time, by the controller, whether the first temperature is at least one of greater than or equal to the predetermined temperature.

8. The hydrogen storage system of claim 7, wherein the instructions further comprise:
transmitting, by the controller, a command to the regulator to place the first tank and the second tank in fluid communication.

9. An article of manufacture including a tangible, non-transitory computer-readable storage medium in electronic communication with a controller, having instructions stored thereon that, in response to execution by the controller, cause the controller to perform operations comprising:
receiving, by the controller, a first temperature from a first tank on tank valve (OTV) temperature sensor;
receiving, by the controller, a second temperature from a second tank OTV temperature sensor;
determining, by the controller, whether the first temperature is at least one of greater than or equal to a predetermined temperature;
determining, by the controller, whether the second temperature is at least one of greater than or equal to the predetermined temperature;
in response to finding that at least one of the first temperature or the second temperature is at least one of greater than or equal to the predetermined temperature, transmitting, by the controller, a stop fuel command.

10. The article of manufacture of claim 9, wherein the instructions further comprise transmitting, by the controller, the stop fuel command to an electronically controlled flow controller of a fueling station.

11. The article of manufacture of claim 10, wherein the instructions further comprise transmitting, by the controller, the stop fuel command to a regulator in electronic communication with the controller.

12. The article of manufacture of claim 11, wherein the stop fuel command commands the regulator to fluidically isolate a first tank from a second tank in response to the stop fuel command.

13. The article of manufacture of claim 12, wherein the instructions further comprise:
waiting, by the controller, for a time interval between a first time and a second time;
determining, at the second time, by the controller, whether the first temperature is at least one of greater than or equal to the predetermined temperature.

14. The article of manufacture of claim 13, wherein the instructions further comprise:
transmitting, by the controller, a command to the regulator to place the first tank and the second tank in fluid communication.

15. A method comprising:
receiving, by a controller, a first temperature from a first tank on tank valve (OTV) temperature sensor;
receiving, by the controller, a second temperature from a second tank OTV temperature sensor;
determining, by the controller, whether the first temperature is at least one of greater than or equal to a predetermined temperature;
determining, by the controller, whether the second temperature is at least one of greater than or equal to the predetermined temperature;
in response to finding that at least one of the first temperature or the second temperature is at least one of greater than or equal to the predetermined temperature, transmitting, by the controller, a stop fuel command.

16. The method of claim 15, further comprising transmitting, by the controller, the stop fuel command to an electronically controlled flow controller of a fueling station.

17. The method of claim 15, further comprising transmitting, by the controller, the stop fuel command to a regulator in electronic communication with the controller.

18. The method of claim 17, wherein the stop fuel command commands the regulator to fluidically isolate a first tank from a second tank in response to the stop fuel command.

19. The method of claim 18, wherein the instructions further comprise:
waiting, by the controller, for a time interval between a first time and a second time;
determining, at the second time, by the controller, whether the first temperature is at least one of greater than or equal to the predetermined temperature.

20. The method of claim 19, wherein the instructions further comprise:
transmitting, by the controller, a command to the regulator to place the first tank and the second tank in fluid communication.
